(19) United States
(12) Patent Application Publication
(10) Pub. No.: US 2016/0063874 A1
(43) Pub. Date: Mar. 3, 2016

(54) EMOTIONALLY INTELLIGENT SYSTEMS

(71) Applicant: Microsoft Corporation, Redmond, WA (US)

(72) Inventors: Mary P. Czerwinski, Kirkland, WA (US); Melissa N. Lim, Seattle, WA (US); Ran Gilad-Bachrach, Bellevue, WA (US); Ivan Tashev, Kirkland, WA (US); Margaret Mitchell, Seattle, WA (US); MariaElaina Martinelli, Moscow, ID (US); William B. Dolan, Kirkland, WA (US)

(21) Appl. No.: 14/472,113

(22) Filed: Aug. 28, 2014

(51) Int. Cl. G09B 5/06; G06F 17/24

(52) U.S. Cl. CPC G09B 5/06; G06F 17/24

(57) ABSTRACT

A digital personal assistant is described that determines a mental or emotional state of a user based on one or more signals and, based on the determined mental or emotional state, provides the user with feedback concerning an item of content generated thereby or an activity to be conducted thereby. An API is described that can be used by diverse applications and/or services to communicate with the digital personal assistant for the purpose of obtaining information about the current mental or emotional state of the user. Content tagging logic is described that identifies one or more items of content generated or interacted with by the user and stores metadata in association with the identified item(s) of content. The metadata includes information indicative of the current mental or emotional state of the user during the time period when the user generated or interacted with the content.

### BACKGROUND

As used here, the term “digital personal assistant” refers to a software agent that can perform tasks, or services, for an individual. Such tasks or services may be performed, for example, based on user input, location awareness, and the ability to access information from various online sources (such as weather or traffic conditions, news, stock prices, user schedules, retail prices, etc.). Some examples of conventional digital personal assistants include CORTANA® (published by Microsoft Corporation of Redmond, Wash. as part of the WINDOWS® 8.1 operating system), SIRI® (published by Apple Computer of Cupertino, Calif.), and GOOGLE NOW™ (published by Google, Inc. of Mountain View, Calif.).

### SUMMARY

A digital personal assistant is described herein that is operable to determine the mental or emotional state of a user based on one or more signals and then, based on the determined mental or emotional state, provide the user with feedback concerning an item of content generated by the user or an activity to be conducted by the user. An API is also described herein that can be used by diverse applications and/or services to communicate with the digital personal assistant for the purpose of obtaining information about the current mental or emotional state of the user. Such applications and services can then use the information about the current mental or emotional state of the user to provide various features and functionality. Content tagging logic is also described herein. The content tagging logic is operable to identify one or more items of content generated or interacted with by the user and to store metadata in association with the identified item(s) of content. The metadata includes information indicative of the current mental or emotional state of the user during the time period when the user generated or interacted with the content. Such metadata can be used to organize and access content based on the user's mental or emotional state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of a system that implements a digital personal assistant that is capable of determining a mental or emotional state of a user based on a variety of signals and then utilizing and/or sharing this information with other applications or services to assist the user in a variety of ways.

FIG. 2 is a block diagram of a user content/activity feedback system that may be implemented by a digital personal assistant, alone or in conjunction with other applications or services.

FIGS. 3A, 3B, and 3C illustrate one scenario in which the user content/activity feedback system of FIG. 2 may operate to provide feedback to a user about user-generated content.

FIG. 4 depicts a flowchart of a method by which a digital personal assistant or other automated component(s) may operate to provide feedback to a user about content generated thereby.

FIG. 5 depicts a flowchart of a method by which a digital personal assistant or other automated component(s) may operate to provide feedback to a user about an activity to be conducted thereby.

FIG. 6 is a block diagram of a system that includes an application programming interface (API) that enables diverse applications and services to obtain information about a user's current mental or emotional state from a digital personal assistant.

FIG. 7 is a diagram that illustrates a two-dimensional identification system that may be used to characterize the current mental or emotional state of a user.

FIG. 8 depicts a flowchart of a method for sharing information about a current mental or emotional state of a user with one or more applications or services.

FIG. 9 depicts a flowchart of a method by which one or more applications or services can provide signals to user mental/emotional state determination logic so that such logic can determine a current mental or emotional state of a user therefrom.

FIG. 10 depicts a flowchart of method for tagging content generated or interacted with by a user with metadata that includes information indicative of a mental or emotional state of the user.

FIG. 11 is a block diagram of an example mobile device that may be used to implement various embodiments.

FIG. 12 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

Conventional digital personal assistants are programmed to make smart suggestions based on mostly external factors, such as a user's location, but typically do not take into account the user's internal context—what the user is currently feeling. In contrast, embodiments described herein relate to a digital personal assistant that can determine the current mental or emotional state of a user based on a variety of signals and then utilize and/or share this information with other applications or services to assist the user in a variety of ways.

In accordance with certain embodiments, a digital personal assistant is provided that is operable to determine the mental or emotional state of a user based on one or more signals and then, based on the determined mental or emotional state, provide the user with feedback concerning an item of content generated by the user or an activity to be conducted by the user.

In accordance with further embodiments, a digital personal assistant is provided that is operable to monitor one or more signals and to intermittently determine therefrom a current mental or emotional state of a user. In further accordance with such embodiments, an application programming interface (API) is provided that can be used by diverse applications and/or services to communicate with the digital personal assistant for the purpose of obtaining therefrom information about the current mental or emotional state of the user. Such applications and services can then use the information about the current mental or emotional state of the user to provide various features and functionality.

In accordance with still further embodiments, a digital personal assistant is provided that is operable to monitor one or more signals and to intermittently determine therefrom a current mental or emotional state of a user. Content tagging logic is also provided. The content tagging logic may comprise part of the digital personal assistant or may be separate therefrom. The content tagging logic is operable to identify one or more items of content generated or interacted with by the user and to store metadata in association with the identified item(s) of content. The metadata includes information indicative of the current mental or emotional state of the user during the time period when the user generated or interacted with the content. Such metadata can be used to organize and access content based on user mental or emotional state.

Section II describes an example system that implements a digital personal assistant that is capable of determining a mental or emotional state of a user based on a variety of signals and then utilizing and/or sharing this information with other applications or services to assist the user in a variety of ways. Section III describes how a digital personal assistant can utilize such mental or emotional state information to provide a user with feedback concerning content generated thereby or an activity to be conducted thereby. Section IV provides further details concerning the mental or emotional state information that may be generated by the digital personal assistant and also describes an example API that can be used by diverse applications and services to obtain the mental or emotional state information therefrom. Section V describes how such mental or emotional state information may be used as metadata for tagging content generated or interacted with by a user and how such tagging can facilitate the organization and searching of content based on mental or emotional state. Section VI describes an example mobile device that may be used to implement a digital personal assistant in accordance with embodiments described herein. Section VII describes an example desktop computer that may be used to implement a digital personal assistant in accordance with embodiments described herein. Section VIII describes some additional exemplary embodiments. Section IX provides some concluding remarks.

### II. Example System that Implements a Digital Personal Assistant that can Determine a Mental or Emotional State of a User

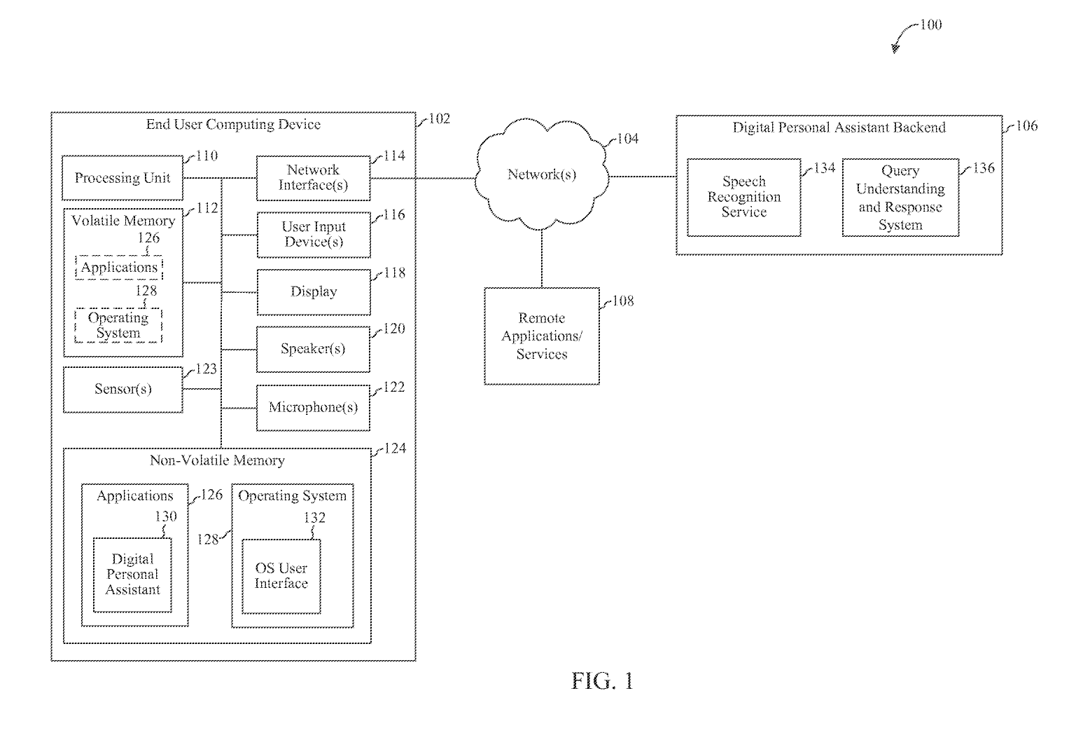

FIG. 1 is a block diagram of a system 100 that implements a digital personal assistant that is capable of determining a mental or emotional state of a user based on a variety of signals and then utilizing and/or sharing this information with other applications or services to assist the user in a variety of ways. As shown in FIG. 1, system 100 includes an end user computing device 102 that is communicatively connected to a digital personal assistant backend 106 and one or more remote applications or services 108 via one or more networks 104. Each of these components will now be described.

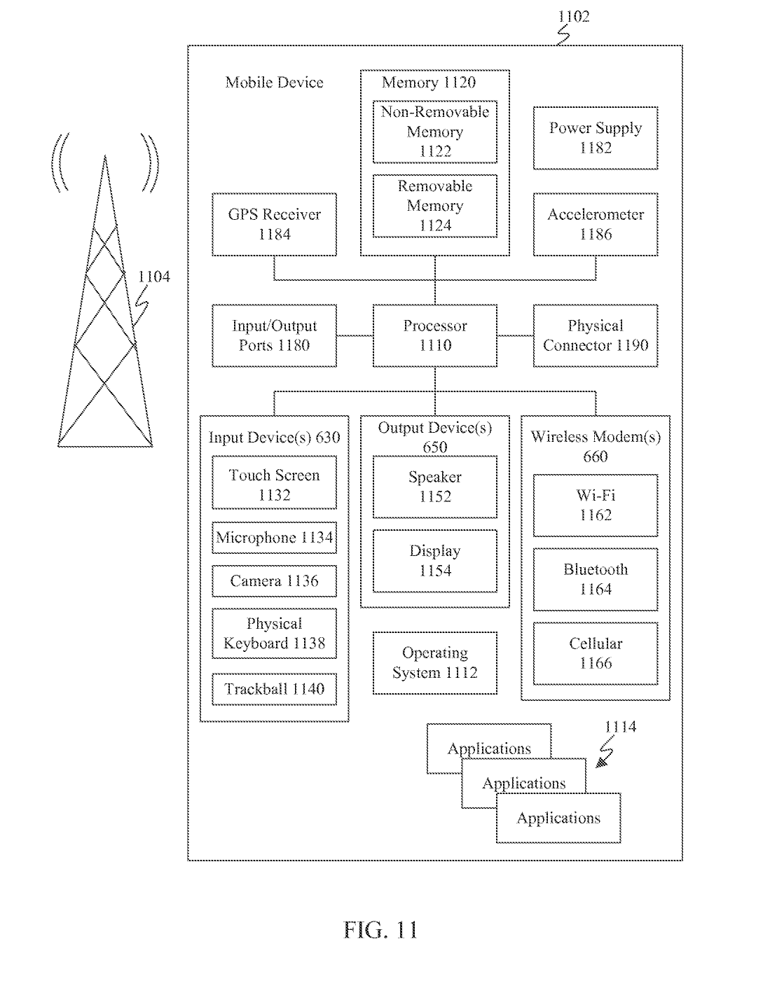

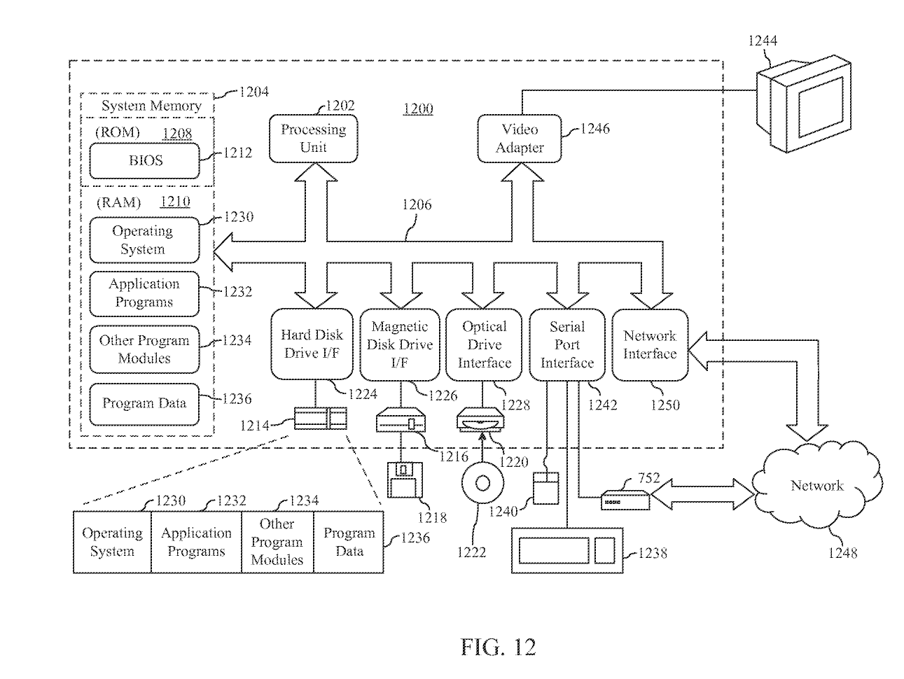

End user computing device 102 is intended to represent a processor-based electronic device that is capable of executing a software-based digital personal assistant 130 that is installed thereon. Digital personal assistant 130 may be executed on behalf of a user of end user computing device 102. In one embodiment, end user computing device 102 comprises a mobile computing device such as a mobile phone (e.g., a smart phone), a laptop computer, a tablet computer, a netbook, a wearable computer such as a smart watch or a head-mounted computer, a portable media player, a handheld gaming console, a personal navigation assistant, a camera, or any other mobile device capable of executing a digital personal assistant on behalf of a user. One example of a mobile device that may incorporate the functionality of end user computing device 102 will be discussed below in reference to FIG. 11. In another embodiment, end user computing device 102 comprises a desktop computer, a gaming console, or other non-mobile computing platform that is capable of executing a digital personal assistant on behalf of a user. An example desktop computer that may incorporate the functionality of end user computing device 102 will be discussed below in reference to FIG. 12.

End user computing device 102 is capable of communicating with digital personal assistant backend 106 and remote applications/services 108 via network 104. Digital personal assistant backend 106 comprises one or more computers (e.g., server computers) that are programmed to provide services in support of the operations of digital personal assistant 130 and other digital personal assistants executing on other end-user computing devices. For example, digital personal assistant backend 106 may include one or more computers configured to provide services to digital personal assistant 130 relating to speech recognition and query understanding and response. In particular, as shown in FIG. 1, these services are respectively provided by a speech recognition service 134 and a query understanding and response system 136. It is noted that digital personal assistant backend 106 may perform any number of other services on behalf of digital personal assistant 130 although such additional services may not be explicitly described herein.

In one embodiment, digital personal assistant backend 106 comprise a cloud-based backend in which any one of a large number of suitably-configured machines may be arbitrarily selected to render one or more desired services in support of digital personal assistant 130. As will be appreciated by persons skilled in the relevant art(s), such a cloud-based implementation provides a reliable and scalable framework for providing backend services to digital personal assistants, such as digital personal assistant 130.

Remote applications/services 108 comprise computer programs executing on machines other than end user computing device 102. As will be described in detail herein, remote applications/services 108 may be configured to communicate with digital personal assistant 130 for the purposes of obtaining information therefrom concerning a mental or emotional state of a user of end user computing device 102. Such applications and services can then use such information to provide various features and functionality to the user and/or to other entities.

Network(s) 104 is intended to represent any type of network or combination of networks suitable for facilitating communication between computing devices, such as end user computing device 102 and the computing devices used to implement digital personal backend 106 and remote application/services 108. Network(s) 104 may include, for example and without limitation, a wide area network (e.g., the Internet), a local area network, a private network, a public network, a packet network, a circuit-switched network, a wired network, and/or a wireless network.

As further shown in FIG. 1, end user computing device 102 includes a plurality of interconnected components, including a processing unit 110, volatile memory 112, non-volatile memory 124, one or more network interfaces 114, one or more user input devices 116, a display 118, one or more speakers 120, one or more microphones 122, and one or more sensors 123. Each of these components will now be described.

Processing unit 110 is intended to represent one or more microprocessors, each of which may comprise one or more central processing units (CPUs) or microprocessor cores. Processing unit 110 may be implemented using other types of integrated circuits as well. Processing unit 110 operates in a well-known manner to execute computer programs (also referred to herein as computer program logic). The execution of such computer programs causes processing unit 110 to perform operations including operations that will be described herein. Each of volatile memory 112, non-volatile memory 124, network interface(s) 114, user input device(s) 116, display 118, speaker(s) 120, microphone(s) 122 and sensor(s) 123 is connected to processing unit 110 via one or more suitable interfaces.

Non-volatile memory 124 comprises one or more computer-readable memory devices that operate to store computer programs and data in a persistent manner, such that stored information will not be lost even when end user computing device 102 is without power or in a powered down state. Non-volatile memory 124 may be implemented using any of a wide variety of non-volatile computer-readable memory devices, including but not limited to, read-only memory (ROM) devices, solid state drives, hard disk drives, magnetic storage media such as magnetic disks and associated drives, optical storage media such as optical disks and associated drives, and flash memory devices such as USB flash drives.

Volatile memory 112 comprises one or more computer-readable memory devices that operate to store computer programs and data in a non-persistent manner, such that the stored information will be lost when end user computing device 102 is without power or in a powered down state. Volatile memory 112 may be implemented using any of a wide variety of volatile computer-readable memory devices including, but not limited to, random access memory (RAM) devices.

Display 118 comprises a device to which content, such as text and images, can be rendered so that it will be visible to a user of end user computing device 102. Some or all of the rendering operations required to display such content may be performed by processing unit 110. Some or all of the rendering operations may also be performed by a display device interface such as a video or graphics chip or card (not shown in FIG. 1) that is coupled between processing unit 110 and display 118. Depending upon the implementation of end user computing device 102, display 118 may comprise a device that is integrated within the same physical structure or housing as processing unit 110 or may comprise a monitor, projector, or other type of device that is physically separate from a structure or housing that includes processing unit 110 and connected thereto via a suitable wired and/or wireless connection.

Speaker(s) 120 comprise one or more electroacoustic transducers that produce sound in response to an electrical audio signal. Speaker(s) 120 provide audio output to a user of end user computing device. Some or all of the operations required to produce the electrical audio signal(s) that are received by speaker(s) 120 may be performed by processing unit 110. Some or all of these operations may also be performed by an audio interface such as an audio chip or card (not shown in FIG. 1) that is coupled between processing unit and speaker(s) 120. Depending upon the implementation of end user computing device 102, speaker(s) 120 may comprise device(s) that are integrated within the same physical structure or housing as processing unit 110 or may comprise external speaker(s) that are physically separate from a structure or housing that includes processing unit 110 and connected thereto via suitable wired and/or wireless connections.

Microphone(s) 122 comprise one or more acoustic-to-electric transducers, each of which operates to convert sound waves into a corresponding electrical audio signal. The electrical audio signal may be processed by processing unit 110 or an audio chip or card (not shown in FIG. 1) that is coupled between microphone(s) 122 and processing unit 110 for use in a variety of applications including but not limited to voice-based applications. Depending upon the implementation of end user computing device 102, microphone(s) 122 may comprise device(s) that are integrated within the same physical structure or housing as processing unit 110 or may comprise external microphone(s) that are physically separate from a structure or housing that includes processing unit 110 and connected thereto via suitable wired and/or wireless connections.

User input device(s) 116 comprise one or more devices that operate to generate user input information in response to a user's manipulation or control thereof. Such user input information is passed via a suitable interface to processing unit 110 for processing thereof. Depending upon the implementation, user input device(s) 116 may include a touch screen (e.g., a touch screen integrated with display 118), a keyboard, a keypad, a mouse, a touch pad, a trackball, a joystick, a pointing stick, a wired glove, a motion tracking sensor, a game controller or gamepad, or a video capture device such as a camera. However, these examples are not intended to be limiting and user input device(s) 116 may include other types of devices other than those listed herein. Depending upon the implementation, each user input device 116 may be integrated within the same physical structure or housing as processing unit 110 (such as an integrated touch screen, touch pad, or keyboard on a mobile device) or physically separate from a physical structure or housing that includes processing unit 110 and connected thereto via a suitable wired and/or wireless connection.

Sensor(s) 123 comprise one or more devices that detect or sense physical stimulus (such as motion, light, heat, sound, pressure, magnetism, etc.) and generate a resulting signal (e.g., for measurement or control). Example sensors 123 that may be included in end user computing device 102 may include but are not limited to a camera, an electrodermal activity sensor or Galvanic Skin Response (GSR) sensor, a heart rate sensor, an accelerometer, a digital compass, a gyroscope, a Global Position System (GPS) sensor, and a pressure sensor associated with an input device such as a touch screen or keyboard/keypad. Various other sensor types are described herein. Signals generated by sensor(s) 123 may be collected and processed by processing unit 110 or other logic within end user computing device 102 to support a variety of applications.

Network interface(s) 114 comprise one or more interfaces that enable end user computing device 102 to communicate over one or more networks 104. For example, network interface(s) 114 may comprise a wired network interface such as an Ethernet interface or a wireless network interface such as an IEEE 802.11 (“Wi-Fi”) interface or a 3G telecommunication interface. However, these are examples only and are not intended to be limiting.

As further shown in FIG. 1, non-volatile memory 124 stores a number of software components including a plurality of applications 126 and an operating system 128.

Each application in plurality of applications 126 comprises a computer program that a user of end user computing device 102 may cause to be executed by processing unit 110. The execution of each application causes certain operations to be performed on behalf of the user, wherein the type of operations performed will vary depending upon how the application is programmed Applications 126 may include, for example and without limitation, a telephony application, an e-mail application, a messaging application, a Web browsing application, a calendar application, a utility application, a game application, a social networking application, a music application, a productivity application, a lifestyle application, a word processing application, a reference application, a travel application, a sports application, a navigation application, a healthcare and fitness application, a news application, a photography application, a finance application, a business application, an education application, a weather application, a books application, a medical application, or the like. As shown in FIG. 1, applications 126 include a digital personal assistant 130, the functions of which will be described in more detail herein.

Applications 126 may be distributed to and/or installed on end user computing device 102 in a variety of ways, depending upon the implementation. For example, in one embodiment, at least one application is downloaded from an application store and installed on end user computing device 102. In another embodiment in which end user device 102 is utilized as part of or in conjunction with an enterprise network, at least one application is distributed to end user computing device 102 by a system administrator using any of a variety of enterprise network management tools and then installed thereon. In yet another embodiment, at least one application is installed on end user computing device 102 by a system builder, such as by an original equipment manufacturer (OEM) or embedded device manufacturer, using any of a variety of suitable system builder utilities. In a further embodiment, an operating system manufacturer may include an application along with operating system 128 that is installed on end user computing device 102.

Operating system 128 comprises a set of programs that manage resources and provide common services for applications that are executed on end user computing device 102, such as applications 126. Among other features, operating system 128 comprises an operating system (OS) user interface 132. OS user interface 132 comprises a component of operating system 128 that generates a user interface by which a user can interact with operating system 128 for various purposes, such as but not limited to finding and launching applications, invoking certain operating system functionality, and setting certain operating system settings. In one embodiment, OS user interface 132 comprises a touch-screen based graphical user interface (GUI), although this is only an example. In further accordance with such an example, each application 126 installed on end user computing device 102 may be represented as an icon or tile within the GUI and invoked by a user through touch-screen interaction with the appropriate icon or tile. However, any of a wide variety of alternative user interface models may be used by OS user interface 132.

Although applications 126 and operating system 128 are shown as being stored in non-volatile memory 124, it is to be understood that during operation of end user computing device 102, copies of applications 126, operating system 128, or portions thereof, may be loaded to volatile memory 112 and executed therefrom as processes by processing unit 110.

Digital personal assistant 130 comprises a computer program that is configured to perform tasks, or services, for a user of end user computing device 102 based on user input as well as features such as location awareness and the ability to access information from a variety of sources including online sources (such as weather or traffic conditions, news, stock prices, user schedules, retail prices, etc.). Examples of tasks that may be performed by digital personal assistant 130 on behalf of the user may include, but are not limited to, placing a phone call, launching an application, sending an e-mail or text message, playing music, scheduling a meeting or other event on a user calendar, obtaining directions to a location, obtaining a score associated with a sporting event, posting content to a social media Web site or microblogging service, recording reminders or notes, obtaining a weather report, obtaining the current time, setting an alarm, obtaining a stock price, finding a nearby commercial establishment, performing an Internet search, or the like. Digital personal assistant 130 may use any of a variety of artificial intelligence techniques to improve its performance over time through continued interaction with the user. Digital personal assistant 130 may also be referred to as an intelligent personal assistant, an intelligent software assistant, a virtual personal assistant, or the like.

Digital personal assistant 130 is configured to provide a user interface by which a user can submit questions, commands, or other verbal input and by which responses to such input or other information may be delivered to the user. In one embodiment, the input may comprise user speech that is captured by microphone(s) 122 of end user computing device 102, although this example is not intended to be limiting and user input may be provided in other ways as well. The responses generated by digital personal assistant 130 may be made visible to the user in the form of text, images, or other visual content shown on display 118 within a graphical user interface of digital personal assistant 130. The responses may also comprise computer-generated speech or other audio content that is played back via speaker(s) 120.

In accordance with embodiments, digital personal assistant 130 is additionally configured to monitor one or more signals associated with a user of end user computing device 102 and to analyze such signal(s) to intermittently determine a current mental or emotional state of the user. As used herein, the term “mental state” is intended to broadly encompass any mental condition or process that may be experienced by a user and the term “emotional state” is intended to encompass any one or more of affects, emotions, feelings, or moods of a user. In further accordance with such embodiments, digital personal assistant 130 may be configured to utilize information concerning the determined mental or emotional state of the user to assist the user in a variety of ways. Additionally or alternatively, digital personal assistant 130 may be configured to share information concerning the determined mental or emotional state of the user with other applications 126 executing on end user computing device 102 or remote applications/services 108 so that such applications and services can provide various features and functionality that leverage such information.

Various types of signals that may be used by digital personal assistant 130 to determine user mental or emotional state will now be described. Depending on the signal type, the signal may be obtained by end user computing device 102 (e.g., by one or more of microphone(s) 122, sensor(s) 123 or user input device(s) 116) or received from other devices that are communicatively connected thereto, including both local devices (e.g., devices worn by the user or otherwise co-located with the user, such as in the user's home or office) and remote devices, including but not limited to the computing device(s) that implement digital personal assistant backend 106 and remote/applications services 108. The description of signals provided below is exemplary only and is by no means intended to be limiting.

User's Facial Expressions.

A user's facial expressions may be obtained (e.g., by at least one camera included within end user computing device 102) and analyzed to help determine the user's current mental or emotional state. For example, a user's facial expressions may be analyzed to identify recent signs of stress or tiredness or, alternatively, that he or she is calm and relaxed.

User's Voice.

Samples of a user's voice may be obtained (e.g., by microphone(s) 122 included within end user computing device 102) and analyzed to help determine the user's current mental or emotional state. For example, if it is detected that the user's vocal cords are constricted, or if the user's voice otherwise demonstrates agitation, then this may indicate that the user is under stress. As another example, if the pitch of the user's voice becomes higher, then this may indicate happiness. As yet another example, the use of a monotonous tone may indicate sadness. Still other features of the user's voice may be analyzed to help determine the mental or emotional state of the user.

User Location.

User location may be obtained from a GPS sensor or from some other location-determining component or service that exists on end user computing device 102 or is otherwise accessible thereto. An algorithm may be implemented that can identify locations where the user tends to be in a certain mental or emotional state. For example, such an algorithm may be used to identify locations where the user tends to be happy or relaxed or where the user tends to be sad or experience stress. By leveraging information about the location of the user, then, it can be determined whether the user is approaching or at a location where he will be in one of those mental or emotional states.

Rate at which User is Turning on and Off Mobile Device.

In an embodiment in which end user computing device 102 is a mobile device such as a smart phone, information about the user's mental or emotional state can be obtained by analyzing how frequently the user is turning on and off the mobile device. For example, if a user is turning on and off the mobile device at a relatively high rate, this may indicate that the user is under stress.

Input Device Interaction Metadata.

In an embodiment in which end user computing device 102 includes or is connected to a keyboard, keypad or other input device upon which a user may type, the speed of the user's typing may be analyzed to determine the user's mental or emotional state. For example, if the typing speed of the user is relatively high, then this may be indicative that the user is agitated or under stress. Similarly, the speed at which a user taps or swipes a touchscreen can be used to help determine the user's mental or emotional state. The rate of errors in keystrokes or gestures may also be analyzed to determine mental or emotional state.

In an embodiment in which end user computing device 102 includes or is connected to a pressure-sensitive input device such as a pressure-sensitive keyboard, keypad or touchscreen, the amount of pressure applied by the user while using such an input device (i.e., while typing on a keyboard or keypad or tapping or swiping a touchscreen) can be monitored to help determine the user's mental or emotional state. For example, a relatively high level of pressure may indicate that the user is under stress. For touchscreens and capacitive mice, contact area may also be considered.

Analysis of Written or Spoken Content of the User.

Written content generated by a user (e.g., text input by the user into end user computing device 102) or spoken content generated by a user (e.g., spoken content captured by microphone(s) 122 of end user computing device 102) may be analyzed to help determine the user's mental or emotional state. For example, the use of certain words may indicate that the user is in a positive or negative state of mind. Additionally, the amount and type of punctuation marks and/or emoticons included by the user in written text may be indicative of his/her mental or emotional state. For example, the use of a relatively large number of exclamation points may indicate that the user is happy. Still other analysis techniques may be applied to the verbal content spoken or written by the user to help determine the user's mental or emotional state.

Application Interaction Metadata.

The type of applications with which a user interacts and the manner of such interaction may be analyzed to help determine the user's mental or emotional state. For example, the frequency at which a user switches context between different applications installed on end user computing device 102 may be monitored and used to help determine the user's mental or emotional state. For example, a relatively high switching frequency may indicate that the user is under stress while a relatively low switching frequency may indicate the opposite.

As another example, the amount of time a user spends in an application may be indicative of their mental or emotional state. For example, if a user is spending a relatively long time in a social media application as FACEBOOK, this may indicate that the user is bored. On the other hand, if the user is spending a relatively long time in an e-mail application, this may indicate that the user is extremely focused.

The degree to which a user is watching or reading while using an application versus typing or gesturing may be analyzed to determine the user's mental or emotional state.

Music or videos being played by a user via a media application and the metadata associated with such music or videos may be analyzed to determine the user's mental or emotional state.

Accelerometer, Compass and/or Gyroscope Output.

The speed of movement of a user may be obtained from an accelerometer within end user computing device 102 and used to help determine the user's mental or emotional state. For example, it may be determined that a user is typically under more stress when in a moving vehicle than when walking. The direction in which a user is heading as provided by a compass and the orientation of a user as determined by a gyroscope or magnetometer may also be used to determine a user's mental or emotional state.

Exposure to Light.

An ambient light sensor or other suitable sensor within end user computing device 102 may be used to determine how long a user has been exposed to light and how much light the user has been exposed to. Such a sensor may also be used to determine the time of year, whether the user is inside or outside, whether it is day or night, or even the user's vitamin D level. This information can be used to help determine the user's mental or emotional state.

Temperature.

A thermometer within end user computing device 102 may be used to determine things like the time of year, whether the user is inside or outside, and the like. Such information can be used to help determine the user's mental or emotional state.

Air Pressure.

A barometer within end user computing device 102 may be used to determine the air pressure where the user is located, which can be used to help determine the user's mental or emotional state.

Weather Conditions, Traffic Conditions, Pollution Levels, and Allergen Levels.

A weather application and/or one or more sensors (e.g., a thermometer, an ambient light sensor, etc.) may be used to determine the weather conditions that a user is experiencing. This information may then be used to help determine the user's mental or emotional state. For example, it may be determined that the user is more likely to be happy when it is sunny out and more likely to be sad when it is overcast or raining. Information may also be obtained concerning local traffic conditions, pollution levels and allergen levels, and this information may also be used to help determine the user's mental or emotional state.

Activity Level of User.

The degree to which the user is active may be determined by monitoring a user's calendar, tracking a user's movements over the course of a day, or via some other mechanism. This information may then be used to help determine the user's mental or emotional state. For example, if it is determined that the user has spent much of the day in meetings, then this may indicate that the user is likely to be tired.

Heart Rate, Heart Rate Variability and Electrodermal Activity.

A camera included within end user computing device 102 may be used to analyze the color of the user's skin to determine blood flow for measuring the user's heart rate and/or heart rate variability. Such information may then be used to help determine the user's mental or emotional state. Additionally, suitable sensors of computing device 102 may be used to measure electrodermal activity (EDA), which are autonomic changes in the electrical properties of the user's skin. Such EDA measurements can be used to determine the mental or emotional state of the user. To acquire such data, electrodes may be included on an input device that a user touches or on a housing of computing device 102 that is likely to be held by the user (e.g., such as the edges or back of a phone). Still other methods for acquiring EDA data may be used.

Electrocardiogram (ECG) and Electroencephalogram (EEG) Data.

Devices exist that can generate an ECG, which is a record of the electrical activity of the heart of a user, and provide such data to end user computing device 102. Likewise, devices exist that can generate an EEG, which is a record of electrical activity along the scalp of a user, and provide such data to end user computing device 102. Such ECG and EEG data may be used to help determine the mental or emotional state of a user.

Device/Network Connection Information.

Bluetooth, WiFi, cellular, or other connections established by end user computing device 102 may be monitored to help determine the user's mental or emotional state. For example, the fact that the user is connected to certain other devices such as health-related wearable devices, gaming devices, or music devices can help determine the user's mental or emotional state. As another example, determining that the user is connected to a corporate network or a home network can be used to determine whether the user is at work or home. As yet another example, the cellular network to which the user is connected can provide a clue as to where the user is currently located (e.g., if in a different country).

Battery/Charging Information.

The current battery level of end user computing device 102 and whether or not it is in a charging state may also be useful in determining the mental or emotional state of the user. For example, if end user computing device 102 is connected to a charger, this may indicate that the user is likely nearby focused on something else (e.g., at home). However, if the battery is low and it is later in the day, this may indicate that the user is more likely to be tired and out and about.

Proximity to Other People or Objects.

Whether or not the user is proximate to other people or objects as well as the degree of proximity may also be useful in determining the mental or emotional state of the user. The user's proximity to other objects or people may be determined using, for example, a camera and/or microphone(s) 122 of end user computing device 102 or may be inferred from a wide variety of other sensors or signals. As another non-limiting example, a Bluetooth interface may be used to recognize the proximity of other Bluetooth-capable devices. Still other approaches may be used.

Explicitly-Provided User Input about Mental or Emotional State.

In some scenarios, a user may explicitly provide information concerning her mental or emotional state. For example, a user may respond to a direct question or set of questions provided by digital personal assistant 130 concerning her current mental or emotional state.

In an embodiment, machine learning may be used to determine which of a set of user signals is most useful for determining a user's mental or emotional state. For example, a test population may be provided with devices (e.g., devices similar to end user computing device 102) that are capable of collecting user signals, such as any or all of the user signals described above. The users in the test population may then use the devices over time while intermittently self-reporting their mental or emotional states. A machine learner may then take as training input the user signals and the self-reported mental or emotional states and correlate the data so as to determine which user signals are most determinative of a particular mood or mental or emotional state. The user signals that are identified as being determinative (or most determinative) of a particular mental or emotional state may then be included in a mental/emotional state determination algorithm that is then included on end user computing devices that are distributed to the general population.

In the foregoing example, the machine learner is trained by a test population. In a further embodiment, a machine learner may be included as part of digital personal assistant 130 or used in conjunction therewith and trained based on the activities of a particular user to customize the set of signals used for determining mental or emotional state for the particular user. In accordance with such an embodiment, the user may start with a “default” or “general” algorithm for determining mental or emotional state (which may be obtained by training a machine learner with data from a test population as noted above). Then, over time, user signals will be collected by the user's device as well as intermittent input concerning the user's own mental or emotional state. This latter input may be inferred based on a particular set of user signals or explicitly provided by the user. The user signals and the input concerning the user's mental or emotional state are provided as training data to the machine learner. The machine learner can use the training data to better identify and weight the various user signals that will be used to identify the user's mental or emotional state going forward. Thus, the algorithm for determining the user's mental or emotional state can be tuned to the specific characteristics and preferences of the user and to the specific way(s) that he/she expresses emotions. It can also track shifts in these characteristics, preferences and expressions.

Although the foregoing mentions machine learning as one way to identify the set of signals to be used to determine the mental or emotional state of the user, this is not intended to be limiting. As will be readily appreciated by persons skilled in the relevant art(s), a variety of other methods may be used to identify such signals and to process such signals to determine mental or emotional state. Such methods may be carried out utilizing data acquired from testing groups or from users while actual using their devices.

### III. Example Digital Personal Assistant that can Utilize User Mental or Emotional State Information to Provide Feedback about User Content or Activities

As was described above, digital personal assistant 130 can determine a mental or emotional of a user of end user computing device 102 by analyzing one or more signals associated with the user. In this section, embodiments will be described that can utilize such mental or emotional state information to provide feedback to a user about content generated by the user or about an activity that may be conducted by the user.

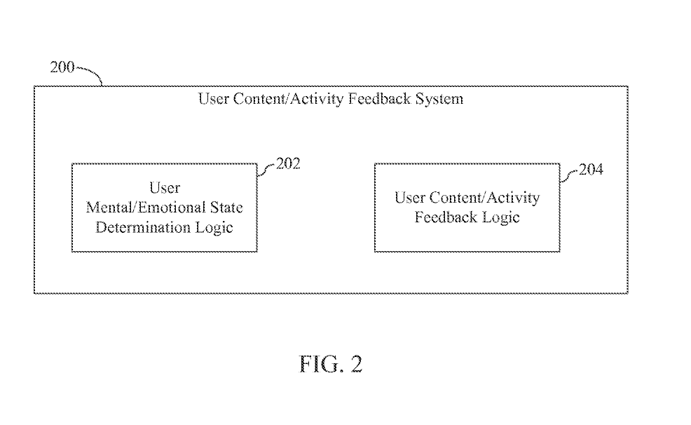

In particular, FIG. 2 is a block diagram of a user content/activity feedback system 200 that may be implemented by digital personal assistant 130, alone or in conjunction with other applications or services executing on or accessible to end user computing device 102. As shown in FIG. 2, user content/activity feedback system 200 includes user mental/emotional state determination logic 202 and user content/activity feedback logic 204.

User mental/emotional state determination logic 202 may comprise part of digital personal assistant 130 or an application or service that is accessible to digital personal assistant 130. User mental/emotional state determination logic 202 is configured to obtain or otherwise receive one or more signals associated with a user of end user computing device 102 and to analyze those signal(s) to determine a current mental or emotional state of the user. The signal(s) may comprise, for example and without limitation, any of the example signals identified as being helpful in determining user mental and/or emotional state as described above in Section II.

User content/activity feedback logic 204 may comprise part of digital personal assistant 130 or an application or service that is capable of obtaining user mental/emotional state information therefrom. User content/activity feedback logic 204 is configured to receive information from user mental/emotional state determination logic 202 that concerns the current mental or emotional state of a user and to leverage that information to generate feedback (e.g., visual, audio and/or haptic feedback) for the user concerning at least one of an item of content generated by the user or at least one activity to be conducted by the user.

Some examples of how user content/activity feedback system 200 may operate to provide feedback to a user about an item of content generated thereby will now be provided.

In accordance with one embodiment, user content/activity feedback system 200 may determine based on the current emotional state of a user that a message generated by the user is likely to contain inappropriate or undesirable content. The message may comprise, for example, and without limitation, a chat message, a text message, an e-mail message, a voice mail message, a social networking message (e.g., a status update to a social networking Web site), or the like. In this case, user content/activity feedback system 200 may provide the user with feedback (e.g., audio feedback, visual feedback and/or haptic feedback) before the user sends the message. Such feedback may notify or otherwise suggest to the user that the message may contain inappropriate or undesirable content, that the user may want to consider not sending the message, and/or that the user may want to consider altering the message in some way.

In one embodiment, user mental/emotional state determination logic 202 may analyze the content of the message itself to determine the mental or emotional state of the user. For example, user mental/emotional state determination logic 202 may analyze words of the message to determine the mental or emotional state of the user. As was previously noted, the use of certain words may indicate that the user is in a positive or negative state of mind. Additionally, the amount and type of punctuation marks included by the user in written text may be indicative of his/her mental or emotional state. Such analysis may be carried out, for example, in a background process that is running while a user is typing a message via a user interface provided by a foreground process. In a scenario in which the user is dictating the message, user mental/emotional state determination logic 202 may also analyze the user's voice to determine the user's mental or emotional state. A variety of other signals, including any of the other signal types mentioned in Section II, may also be used to determine the user's mental or emotional state.

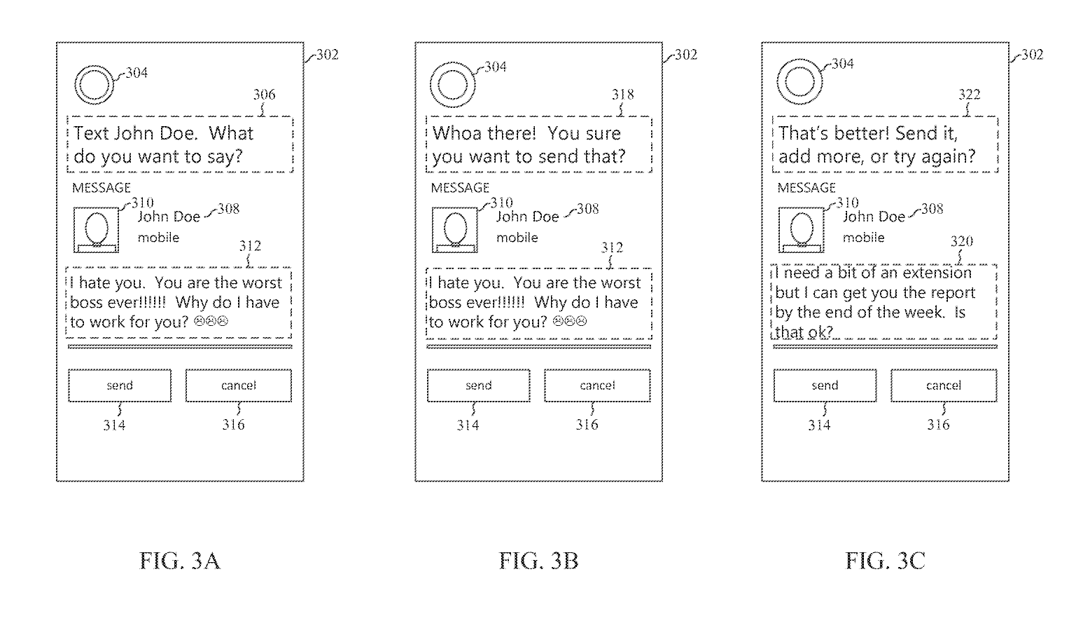

FIGS. 3A, 3B, and 3C illustrate one scenario in which user content/activity feedback system 200 may operate to provide feedback to a user about user-generated content. In particular, these figures show a graphical user interface (GUI) 302 that may be presented to display 118 of end user computing device 102 by digital personal assistant 130. For the purposes of this example, it is to be assumed that the user of end user computing device 102 has indicated to digital personal assistant 130 that she wishes to send a text message to her boss, John Doe.

As shown in FIG. 3A, GUI 302 includes a visual representation 304 of digital personal assistant 130 and a first text prompt 306 generated by digital personal assistant 130 that invites a user of end user computing device 102 to enter the message text. First text prompt 306 reads “Text John Doe. What do you want to say?” As further shown in this figure, GUI 302 also includes a text identifier 308 of the message recipient, an image 310 of the message recipient, and first message text 312 that has been input by the user. First message text 312 includes the text “I hate you. You are the worst boss ever!!!!!! Why do I have to work for you?” as well as several “frowning face” emoticons. As still further shown in this figure, GUI 302 also includes a send button 314 with which the user may interact to send the message and a cancel button 316 with which the user may interact to cancel sending the message.

In accordance with this example, user mental/emotional state determination logic 202 (which may comprise a portion of digital personal assistant 130) analyzes one or more signals associated with the user and determines based upon this analysis that the user is angry. The analyzed signals may include, for example, the words, punctuation marks, and emoticons that comprise message text 312. That is to say, determining that the user is angry may comprise determining an emotional content of message 312. Alternatively or additionally, the analyzed signals may include any of the other types of signals described above in Section II as being helpful in determining user mental or emotional state.

As shown in FIG. 3B, in response to determining that the user is angry (which may comprise determining that the message text 312 comprises angry content as noted above), user content/activity feedback logic 204 (which may comprise a portion of digital personal assistant 130) generates and displays second text prompt 318 that suggests to the user that she might not want to send the message. In particular, second text prompt 318 reads “Whoa there! You sure you want to send that?” This display of second text prompt 318 may advantageously cause the user to reconsider sending what may be an inappropriate message to her boss.

As shown in FIG. 3C, in this example, the user has reconsidered and revised her message in response to viewing the warning embodied in second text prompt 318. In particular, the user has replaced first message text 312 with second message text 320, which reads “I need a bit of an extension but I can get you the report by the end of the week. Is that ok?” In further accordance with this example, user mental/emotional state determination logic 202 analyzes second message text 320 and determine that the emotional content thereof is suitable for sending. Based on this determination, user content/activity feedback logic 204 generates and displays second text prompt 322 that reads “That's better! Send it, add more, or try again?” This prompt indicates to the user that the message is suitable for sending but that it can also be further modified.

In an embodiment, user content/activity feedback logic 204 may be configured to monitor how a user behaves in response to receiving feedback about user-generated content and to consider the user's behavior in determining whether and how to provide feedback about subsequently-generated items of user content. For example, if a user tends to ignore such feedback, then user content/activity feedback logic 204 can adaptively modify its behavior to provide less feedback or no feedback in the future. Furthermore, if a user displays a negative emotional reaction to receiving such feedback (e.g., as detected by user mental/emotional state determination logic 202) or provides explicit input indicating that he or she does not want to receive such feedback (e.g., via an options interface or a dialog with digital personal assistant 130), then user content/activity feedback logic 204 can modify its behavior accordingly to provide less feedback or no feedback in the future. User content/activity feedback logic 204 can also modify how it presents feedback (e.g., direct vs. subtle, voice vs. text, etc.) based on user behavior and/or explicit instruction.

As will be described in Section III below, in certain embodiments, user mental/emotional state determination logic 202 is configured to assign one or more of a confidence level and intensity level to each of one or more possible mental or emotional states of the user. In accordance with such embodiments, user content/activity feedback logic 204 may be configured to consider one or both of confidence level and intensity level in determining whether to provide feedback about user-generated content. For example, user content/activity feedback logic 204 may be configured to provide feedback only if it has been determined based on the user signals that the user is angry with a degree of confidence that exceeds a particular confidence threshold and/or that the intensity of the detected anger exceeds a particular intensity threshold. Furthermore, the type of feedback provided may also be determined based on confidence level and/or intensity level.

In further embodiments, whether feedback is provided by user content/activity feedback logic 204 may be premised in part upon the identity of an intended recipient of a message, or upon other information associated with an intended recipient of a message. For example, user content/activity feedback logic 204 may be configured to provide feedback only about messages to certain professional contacts (e.g., co-workers or a boss), certain personal contacts (a spouse, a former spouse, an ex-girlfriend or ex-boyfriend), or the like. In this manner, the feedback feature can be restricted to operate only when the user intends to communicate with certain individuals.

Another way in which user content/activity feedback system 200 can provide feedback to a user about user-generated content is by decorating or highlighting certain text items within a message or other user-generated content that includes text (e.g., a document). For example, certain words that are determined to be emotional, overly emotional, or inappropriate can be highlighted in some fashion such as by bolding, underlining, or italicizing the words, or changing the color, font, or size of the words. Still other techniques can be used for highlighting such text items. User content/activity feedback system 200 can also be configured to identify an overall emotional content level associated with the text of a particular item of user-generated content as well as indicate how each of the words or other elements of the content contribute to that overall level.

User content/activity feedback logic 204 may also be configured to recommend to a user how to modify a particular item of content to adjust the emotional content or appropriateness thereof. For example, user content/activity feedback logic 204 may be configured to recommend removing, adding, or modifying a particular word, punctuation mark, emoticon, or the like. In a case where user content/activity feedback logic 204 has recommended that a particular word be modified, user content/activity feedback logic 204 may be further configured to present a list of alternate words to the user and the user can select one of these words as a replacement. For example, user content/activity feedback logic 204 may provide a thesaurus service that can enable a user to identify suitable replacement words and may even sort a list of suitable replacement words by emotional content level (e.g., if the goal is to make the text of a document less angry, more neutral or positive word choices could be sorted to the top of the list). However, this is only an example, and still other methods of suggesting changes to content may be used.

In a further embodiment, user content/activity feedback logic 204 may be configured to automatically and intelligently modify user-generated content to achieve a desired emotional level upon request from a user. This feature may be thought of as an emotional auto-correct mechanism. Such auto-correct feature may be configured by the user to operate while the user is typing, suggesting modifications on the fly, or may be applied to an item of content after the user has stopped working with it.

The foregoing techniques are not limited to detecting and providing feedback about negative, angry or inappropriate content, but may be applied to all types of emotional content. For example, user content/activity feedback logic 204 may also be configured to provide feedback about happy or positive content. As a particular example, with reference to the text decoration implementation discussed above, user content/activity feedback logic 204 may be configured to highlight positive or happy content. Such content may be highlighted using a different technique than that used to highlight sad, unhappy or negative content, thereby differentiating it therefrom. For example, a different (e.g., brighter) color or font may be used to distinguish positive or happy content from other types of content. Providing feedback in this fashion can provide the user with an awareness of the tone of the content that she is generating.

As another example, if user mental/emotional state determination logic 202 determines that the user of end user computing device 102 is in a happy emotional state, and the user has just generated content by, for example, taking a picture or recording a video, then user content/activity feedback logic 204 may recommend to the user that she share such content via e-mail or by posting the content to a social networking Web site. As yet another example, if user mental/emotional state determination logic 202 determines that the user of end user computing device 102 is in a happy emotional state, and the user is generating content (e.g., a message or photo) to share with others (e.g., via e-mail, text message, or post to a blog or social networking Web site), then user content/activity feedback logic 204 may recommend to the user to add additional content (e.g., happy emoticons, funny or uplifting music, etc.) thereto, or may automatically add such content if configured to do so by the user.

The foregoing techniques for providing feedback in regard to user-generated content are not limited to messages but can be used with any type of content that can be generated by a user, whether offline or online. Furthermore, the techniques are not limited to a digital personal assistant. For example, the foregoing user feedback features may be incorporated into a word processing program, spreadsheet program, slide show presentation program, or any other application or service that enables a user to generate content. The foregoing techniques are also not limited to text but can be applied to other types of user-generated content, including audio content, image content (including photos), and video content. For example, if user content/activity feedback system 200 determines that a voice-mail message, picture, or video generated by a user contains exceedingly emotional content and/or was generated by the user while in a particular mental or emotional state, then user content/activity feedback system 200 can provide useful feedback to the user about such content.

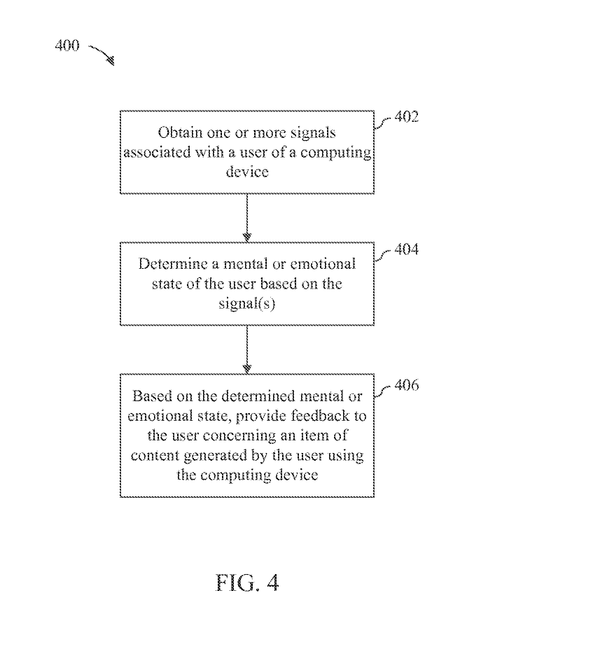

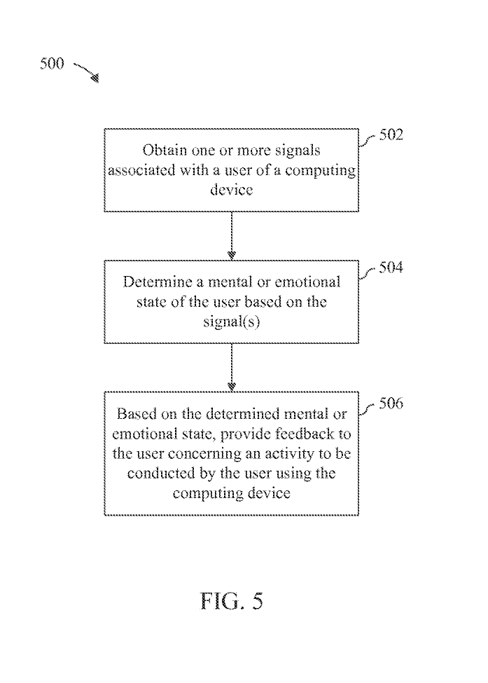

The foregoing techniques may be further understood with reference to flowchart 400 of FIG. 4. In particular, flowchart 400 illustrates a method by which a digital personal assistant or other automated component(s) may operate to provide feedback to a user about content generated thereby. The method of flowchart 400 will now be described with continued reference to user content/activity feedback system 200 as described above in reference to FIG. 2, although the method is not limited to that system. As noted above, user content/activity feedback system 200 may be implemented by digital personal assistant 130, by digital personal assistant 130 operating in conjunction with another application or service, or by a different program entirely.

As shown in FIG. 4, the method of flowchart 400 begins at step 402, in which user mental/emotional state determination logic 202 obtains one or more signals associated with a user of a computing device. The signals may comprise for example and without limitation, any of the signals discussed in Section II above as being useful for determining the mental or emotional state of a user. Thus, for example, step 402 may comprise obtaining one or more of: facial expressions of the user, voice characteristics of the user, a location of the user, an orientation of the user, a proximity of the user to other people or objects, a rate at which the user is turning on and off a mobile device; input device interaction metadata associated with the user, written and/or spoken content of the user, application interaction metadata associated with the user, accelerometer, compass and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

At step 404, user mental/emotional state determination logic 202 determines a mental or emotional state of the user based on the signal(s) obtained during step 402. In accordance with certain embodiments, step 404 may further involve assigning one or more of a confidence level and intensity level to each of one or more possible mental or emotional states of the user.

At step 406, based on the determined mental or emotional state of the user, user content/activity feedback logic 204 provides feedback (e.g., visual, audio and/or haptic feedback) to the user concerning an item of content generated by the user.

In one embodiment, step 406 comprises suggesting to the user that a message generated thereby is not suitable for sharing with one or more intended recipients thereof.

In another embodiment, step 406 comprises highlighting one or more words, punctuation marks or emoticons included in text content generated by the user to indicate that such word(s), punctuation mark(s) or emoticon(s) comprise emotional content.

In yet another embodiment, step 406 comprises recommending that the user delete or replace one or more words, punctuation marks or emoticons included in text content generated by the user.

In still another embodiment, step 406 comprises identifying a list of words having a similar meaning to a word for which replacement is recommended, sorting the list by emotional content level, and presenting the sorted list to the user.

In a further embodiment, step 406 is performed based on the determined mental or emotional state and at least one of a confidence level associated with the determined mental or emotional state and an intensity level associated with the determined mental or emotional state.

In a still further embodiment, step 406 comprises recommending that the user share the item of content with at least one other person.

In an additional embodiment, the method of flowchart 400 further includes determining how the user has responded to receiving the feedback and automatically modifying how additional feedback will be presented to the user in the future based on the determined user response.

The foregoing description of FIGS. 2-4 described how user content/activity feedback system 200 may provide a user with feedback about a particular item of content generated thereby based at least on a determination of a mental or emotional state of the user. In a further embodiment, the determination of the mental or emotional state of the user may also be used by user content/activity feedback system 200 to provide the user with feedback (e.g., visual, audio and/or haptic feedback) about an activity the user intends to conduct, such as an activity the user intends to conduct via end user computing device 102.

For example, in an embodiment, user mental/emotional state determination logic 202 may be configured to determine if the user is inebriated. In further accordance with such an embodiment, user content/activity feedback logic 204 may be configured to prevent a user from conducting certain activities or to suggest or warn the user not to conduct certain activities in response to a determination that the user is inebriated. The activities may include for example, placing a phone call or sending a message to a particular person or to any person, posting a photograph, video or other content to a social networking Web site, purchasing items over the Internet, or the like.

As another example, in response to a determination by user mental/emotional state determination logic 202 that the user is angry or under stress, user content/activity feedback logic 204 may suggest that the user refrain from conducting certain activities that might exacerbate the user's anger or stress, such as placing a phone call to a certain person or party (e.g., the user should not call a company that is known to place users on hold for long periods of time when the user is already under stress), or from conducting certain activities that might be adversely impacted by the user's anger or stress (e.g., the user should not call his boss while he is angry or continue participating in a teleconference until the user has calmed down, the user should not attempt to take photos or record videos with end user computing device 102 while angry, as it is likely his hand(s) will be shaking).

Such a technique may be used to help assist a user avoid engaging in harmful activities as a coping mechanism when under stress. For example, if a user tends to spend money, gamble, or conduct other activities when under stress, user content/activity feedback logic 204 can be configured to prevent a user from performing those activities or warn them about performing such activities when user mental/emotional state determination logic 202 has determined that the user is under stress. For example, when user mental/emotional state determination logic 202 has determined that the user is under stress, user content/activity feedback logic 204 can generate warning messages when it is determined that the user is performing online shopping, online gambling, or some other activity via end user computing device 102.

The foregoing techniques may be further understood with reference to flowchart 500 of FIG. 5. In particular, flowchart 500 illustrates a method by which a digital personal assistant or other automated component(s) may operate to provide feedback to a user about an activity to be conducted thereby. The method of flowchart 500 will now be described with continued reference to user content/activity feedback system 200 as described above in reference to FIG. 2, although the method is not limited to that system. As noted above, user content/activity feedback system 500 may be implemented by digital personal assistant 130, by digital personal assistant 130 operating in conjunction with another application or service, or by a different program entirely.

As shown in FIG. 5, the method of flowchart 500 begins at step 502, in which user mental/emotional state determination logic 202 obtains one or more signals associated with a user of a computing device. The signals may comprise for example and without limitation, any of the signals discussed in Section II above as being useful for determining the mental or emotional state of a user. Thus, for example, step 502 may comprise obtaining one or more of: facial expressions of the user, voice characteristics of the user, a location of the user, an orientation of the user, a proximity of the user to other people or objects, a rate at which the user is turning on and off a mobile device; input device interaction metadata associated with the user, written and/or spoken content of the user, application interaction metadata associated with the user, accelerometer, compass and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

At step 504, user mental/emotional state determination logic 202 determines a mental or emotional state of the user based on the signal(s) obtained during step 502. In accordance with certain embodiments, step 404 may further involve assigning one or more of a confidence level and intensity level to each of one or more possible mental or emotional states of the user.

At step 506, based on the determined mental or emotional state of the user, user content/activity feedback logic 204 provides feedback (e.g., visual, audio and/or haptic feedback) to the user concerning an activity to be conducted by the user. Various examples of such activities were provided above.

The foregoing description explained how information concerning a user's mental or emotional state could be used to provide the user with feedback concerning an item of content generated thereby or an activity to be conducted thereby. In further embodiments, such information may also advantageously be used to determine which kinds of content/activities to suggest to the user (e.g., a stressed mood is detected, so a calming music playlist is suggested to the user). Based on information about the user's mental or emotional state, content that may be proactively offered to a user may be tailored. Such content may include for example and without limitation, suggestions for what to listen to, what to watch, what to read, where to go, what to do, etc.). Furthermore, search results or other responses to content requests made by or on behalf of a user may be filtered based on the current mental or emotional state of the user.

### IV. API-Based Sharing of User Mental/Emotional State Information and Signals for Determining Same

As was described above, digital personal assistant 130 is operable to monitor one or more signals and to intermittently determine therefrom a current mental or emotional state of a user. In a further embodiment, an application programming interface (API) is provided that can be used by diverse applications and/or services to communicate with digital personal assistant 130 for the purpose of obtaining information about the current mental or emotional state of the user. Such applications and services can then use the information about the current mental or emotional state of the user to provide various features and functionality.

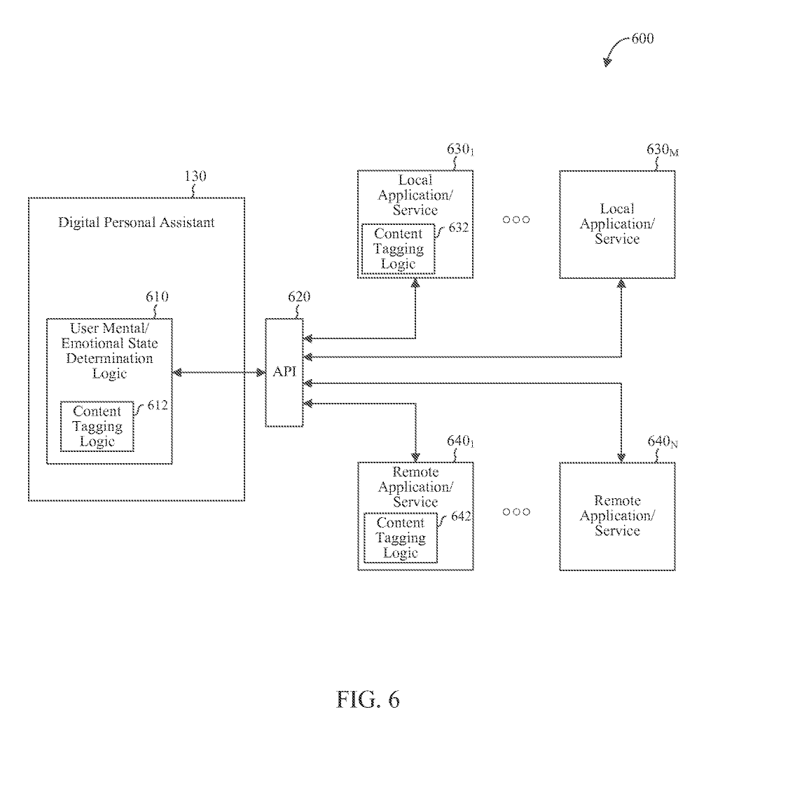

FIG. 6 is provided to help illustrate this concept. In particular, FIG. 6 is a block diagram of a system 600 in which an API is provided to enable diverse applications and services to receive information about a user's current mental or emotional state from digital personal assistant 130. As shown in FIG. 6, digital personal assistant 130 includes user mental/emotional state determination logic 610. User mental/emotional state determination logic 610 is configured to intermittently obtain or otherwise receive one or more signals associated with a user of end user computing device 102 and to analyze those signal(s) to determine a current mental or emotional state of the user. The signal(s) may comprise, for example and without limitation, any of the example signals identified as being helpful in determining user mental and/or emotional state as described above in Section II.

As further shown in FIG. 6, system 600 further includes a plurality of local applications or services 630₁-630_{M} and a plurality remote applications or service 640₁-640_{N}. Each of local applications/services 630₁-630_{M} is intended to represent a different application or service executing on end user computing device 102 with digital personal assistant 130. Each of remote applications/services 640₁-640_{N} is intended to represent a different application or service executing on a device other than end user computing device 130 that is communicatively connected to end user computing device 130 via one or more networks (e.g., network 104).

As still further shown in FIG. 6, system 600 includes an API 620. API may be stored in memory on end user computing device 102. API 620 is intended to represent a common set of functions, routines, or the like, by which communication can be carried out between each of local applications/services 630₁-630_{M} and user mental/emotional state determination logic 610 and between each of remote applications/services 640₁-640_{N} and user mental/emotional state determination logic 610. Such communication may be carried out so that each of local applications/services 630₁-630_{M} and each of remote applications/services 640₁-640_{N} can obtain information about the current mental or emotional state of the user and leverage that information to provide various features and functionality. In an embodiment, API 620 is published so that developers of diverse applications and services (including third party developers other than the developers of digital personal assistant 130) can build functionality around the mental or emotional state information generated by user mental/emotional state determination logic 610.

In one embodiment, API 620 supports a query-based model for reporting user mental or emotional state. In accordance with the query-based model, each of local applications/services 630₁-630_{M} and each of remote applications/services 640₁-640_{N} sends a query to user mental/emotional state determination logic 610 to obtain the current mental or emotional state of the user. In response to receiving the query, user mental/emotional state determination logic 610 sends information about the current mental or emotional state of the user to the querying application or service. The functions or routines used to send queries and provide responses thereto are defined by API 620.

In another embodiment, API 620 supports an update-based model for reporting user mental or emotional state. In accordance with the updated-based model, each of local applications/services 630₁-630_{M} and each of remote applications/services 640₁-640_{N} registers with user mental/emotional state determination logic 610 to receive updates therefrom concerning the mental or emotional state of the user of end user computing device 102. Depending upon the implementation, user mental/emotional state determination logic 610 may send updated mental or emotional state information to registered applications and services at various times. For example, in one embodiment, user mental/emotional state determination logic 610 may periodically send out updated user mental or emotional state information to registered applications and services, regardless of whether the user's mental or emotional state has changed. In another embodiment, user mental/emotional state determination logic 610 may send out updated user mental or emotional state information to registered applications and services only when it has been determined that the user's mental or emotional state has changed in some way. Still other approaches may be used. The functions or routines used to register to receive updated mental or emotional state information and to send such information to registered entities are defined by API 620.

API 620 may also specify a particular information format that may be used to convey a user's current mental or emotional state. A wide variety of formats may be used depending upon the implementation and the information to be conveyed.

For example, user mental/emotional state determination logic 610 may be configured to analyze one or more signals associated with the user to determine whether the user is in one or more of the following emotional states: (1) stressed, (2) happy, (3) calm, (4) sad, or (5) neutral. In one embodiment, user mental/emotional state determination logic 610 is configured to select only a single mental or emotional state from the above list as being representative of the current mental or emotional state of the user. In further accordance with such an embodiment, user mental/emotional state determination logic 610 may also be configured to also generate a confidence level associated with such single mental or emotional state and/or an intensity level associated with such single mental or emotional state.

In another embodiment, user mental/emotional state determination logic 610 is configured to provide confidence levels and/or intensity levels for each mental or emotional state identified in the above-referenced list, or for some subset thereof. This approach may advantageously provide a more complex and detailed view of the user's current mental or emotional state.

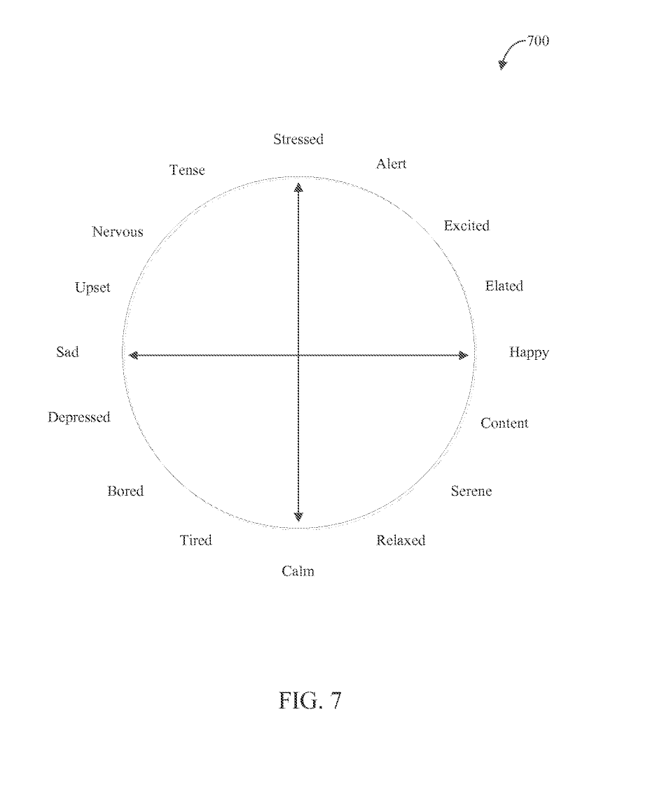

In still further embodiments, user mental/emotional state determination logic 610 is configured to recognize each of the aforementioned emotional states (stressed, happy, calm, sad, and neutral) as well as additional emotional states that may be thought of as variations or combinations of those states. FIG. 7 is a diagram 700 that illustrates one such approach. As shown in FIG. 7, the user's mental or emotional state may be characterized with reference to a two-dimensional identification system, having a horizontal and a vertical axis. The values on the horizontal axis represent arousal and range from calm to stressed. The values on the vertical axis represent valence and range from sad to happy. By generating measurements for a user along each of these axes, various mental or emotional states may be determined that are a combination of sad and stressed (upset, nervous or tense), a combination of happy and stressed (elated, excited or alert), a combination of sad and calm (depressed, bored or tired), or a combination of happy and calm (content, serene or relaxed). As in previous embodiments, each of the mental and/or emotional states can be identified with a certain confidence level and/or intensity level.

Thus, it can be seen that the user mental/emotional state information that may be sent from user mental/emotional state determination logic 610 to local applications/services 630₁-630_{M} and remote applications/services 640₁-640_{N} in accordance with API 620 may take on a variety of forms and convey varying degrees of information. In one embodiment, user mental/emotional state determination logic 610 may be capable of producing different representations of the mental or emotional state of the user and each application or service may be capable of requesting a particular representation type from among the different types. For example, one application or service may request a very simple representation (e.g., a single mental/emotional state) while another application or service may request a more complex representation (e.g., a plurality of mental/emotional states, each with its own confidence level and/or intensity level).

Each application or service that receives user mental/emotional state information from user mental/emotional state determination logic 610 may use the information in a different way to provide functions or features that are driven at least to some extent by the knowledge of the user's current mental or emotional state. For example, a music playing application or service can use the information to select songs or create a playlist that accords with the user's current mental or emotional state. In further accordance with this example, if it is determined that the user is in a happy state, the music application or service can select upbeat or fun songs or create a playlist of upbeat or fun songs for the user to listen to.

As another example, a news application or service can use the user mental/emotional state information to select news articles in a manner that takes into account the user's mood. Thus, for example, if the user is stressed, the news application or service may avoid presenting articles to the user that may increase the user's stress level (e.g., articles about violent crimes, bad economic news, military conflicts, or the like).

Thus, it will be appreciated that any application or service that is capable of selectively presenting content to a user can guide its selection of such content based on the user's current mental or emotional state as obtained via API 620. Such applications or services may include but are in no way limited to Internet search engines, news feeds, online shopping tools, content aggregation services and Web pages, advertisement delivery services, social networking applications and Web pages, or the like.

Other novel applications may be enabled using the user mental or emotional state information received via API 620. For example, a “digital mood ring” application may be implemented that displays an image or other visual representation that changes as the user's mental or emotional state changes. For example, a visual representation of digital personal assistant 130 or a visual representation of a ring may be made to change color depending upon the user's current mental or emotional state. The “digital mood ring” may be displayed, for example, on a wearable device such as a watch or on a phone lock screen in an embodiment in which end user computing device 102 is a smart phone, although these are examples only and are not intended to be limiting.

In certain embodiments, an application or service can query user mental/emotional state determination logic 130 via API 620 to receive a history of the user's mental or emotional states over time. Such history can be used by applications and services to help a user discover how his or her mood has changed over time and/or been impacted by certain events. For example, a calendar application could obtain a history of user mental/emotional state information from user mental/emotional state determination logic 610 via API 620 and use such information to provide a calendar-based representation of the user's moods over a particular time period and may correlate the user's mental/emotional states to certain calendared events. The temporal granularity of the historical mood information that can be provided may vary depending upon how such information is maintained by user mental/emotional state determination logic 610. In accordance with certain embodiments, user mental/emotional state determination logic 610 may be capable of providing mental/emotional state information for various date and time ranges as specified by a requesting application/service.

In a further embodiment, user mental/emotional state determination logic 610 may be capable of predicting the mental or emotional state of a user at a future date or time. This may be achieved, for example, by extrapolating based on observed states and trends. In accordance with such an embodiment, user mental/emotional state determination logic 610 may be capable of sharing such predicted mental or emotional state information with an application or service for use thereby.

Applications or services may be designed that can collect user mental/emotional state information from a group of users by interacting with APIs installed on each of those users' end user computing devices. This advantageously enables the mental or emotional states of entire groups (from very small groups to very large groups) to be monitored. Such group information can be useful for a variety of purposes. For example, such group information can be used to monitor the state of a population during disasters or emergency situations, to monitor experimental and control groups for all types of research, and to predict traffic accidents, election outcomes, market trends or any other phenomenon that may be correlated to the mental or emotional states of a group of people. Such group information can also be used to conduct market research by obtaining feedback from a group of users with respect to how such users respond to a particular advertisement, product or service.

Such group mental/emotional state information can also advantageously be used to help recommend products or services to groups rather than individuals. For example, an application or service could analyze the current mental or emotional state of a group of friends to recommend activities, certain types of cuisine, books (e.g., for a book club), movies, or the like thereto.

As another example, such group mental/emotional state information may be used for targeted advertising and/or content delivery, with different types of advertisements and content being delivered to groups having different mental or emotional states.

The foregoing concepts relating to the sharing of user mental/emotional state information via a common API will now be further described in regard to FIG. 8. In particular, FIG. 8 depicts a flowchart 800 of a method for sharing information about the current mental or emotional state of a user with one or more applications or services. The method of flowchart 800 will now be described with continued reference to system 600 as described above in reference to FIG. 6, although the method is not limited to that system.

As shown in FIG. 8, the method of flowchart 800 begins at step 802 in which user mental/emotional state determination logic 610 monitors one or more signals associated with a user and intermittently determines a current mental or emotional state of the user based on the one or more signals. The one or more signals may comprise for example and without limitation, any of the signals discussed in Section II above as being useful for determining the mental or emotional state of a user. Thus, for example, the one or more signals may comprise one or more of: facial expressions of the user, voice characteristics of the user, a location of the user, an orientation of the user, a proximity of the user to other people or objects, a rate at which the user is turning on and off a mobile device; input device interaction metadata associated with the user, written and/or spoken content of the user, application interaction metadata associated with the user, accelerometer, compass and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

At step 804, user mental/emotional state determination logic 610 provides information about the current mental or emotional state of the user to one or more diverse applications or services via common API 620. The one or more diverse applications or services may comprise, for example, one or more of local applications/services 630₁-630_{M} and remote applications/services 640₁-640_{N}.

In an alternate embodiment, one or more of local applications/services 630₁-630₄ and remote applications/services 640₁-640_{N} can register with user mental/emotional state determination logic 610 to provide thereto one or more signals that can be used by user mental/emotional state determination logic 610 to determine a current mental or emotional state of the user. For example, a health and fitness application that stores information relating to a user's activity level, heart rate, or the like, can provide such information as signals to user mental/emotional state determination logic 610 via API 620 so that user mental/emotional state determination logic 610 can use such signals to help determine the user's current mental or emotional state. This advantageously enables user mental/emotional state determination logic 610 to leverage information acquired by other applications and services to more accurately determine the user's current mental or emotional state.

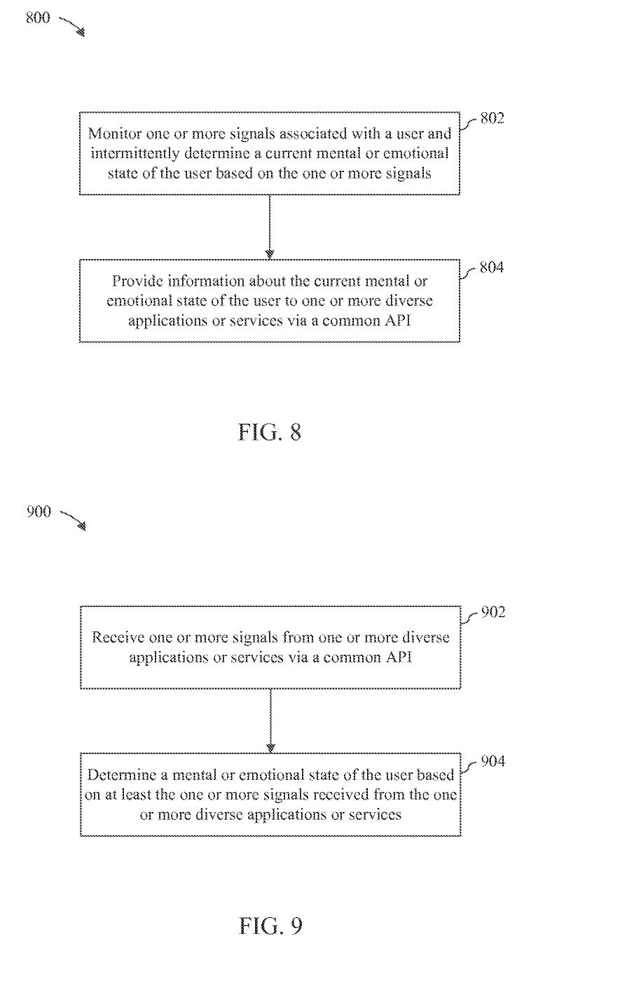

The foregoing concepts relating to the sharing of signals from which user mental/emotional state can be determined via a common API will now be further described in regard to FIG. 9. In particular, FIG. 9 depicts a flowchart 900 of a method by which one or more applications or services can share signals from which a current mental or emotional state of a user can be determined. The method of flowchart 900 will now be described with continued reference to system 600 as described above in reference to FIG. 6, although the method is not limited to that system.

As shown in FIG. 9, the method of flowchart 900 begins at step 902 in which user mental/emotional state determination logic 610 receives one or more signals from one or more diverse applications or services via common API 620. The one or more diverse applications or services may comprise, for example, one or more of local applications/services 630₁-630_{M} and remote applications/services 640₁-640_{N}. The one or more signals may comprise for example and without limitation, any of the signals discussed in Section II above as being useful for determining the mental or emotional state of a user. Thus, for example, the one or more signals may comprise one or more of: facial expressions of the user, voice characteristics of the user, a location of the user, an orientation of the user, a proximity of the user to other people or objects, a rate at which the user is turning on and off a mobile device; input device interaction metadata associated with the user, written and/or spoken content of the user, application interaction metadata associated with the user, accelerometer, compass and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

At step 904, user mental/emotional state determination logic 610 determines a mental or emotional state of the user based on the one or more signals received from the one or more diverse applications or services in step 902.

### V. Tagging of Content with User Mental/Emotional State Metadata

As was discussed above in reference to FIG. 6, digital personal assistant 130 includes user mental/emotional state determination logic 610 that is operable to monitor one or more signals and to intermittently determine therefrom a current mental or emotional state of a user. Furthermore, user mental/emotional state determination logic 610 may share information concerning the current mental or emotional state of the user with one or more of local applications/services 630₁-630_{M} and remote applications/services 640₁-640_{N} via API 620. As further shown in FIG. 6, user mental/emotional state determination logic 610 may include content tagging logic 612. Furthermore, each of local applications/services 630₁-630_{M} and remote applications/services 640₁-640_{N} may include content tagging logic. To illustrate this in FIG. 6, local application/service 630₁ is shown as including content tagging logic 632 and remote application/service 640₁ is shown as including content tagging logic 642.

Content tagging logic 612, content tagging logic 632 and content tagging logic 642 are each configured to identify one or more items of content generated or interacted with by the user and to store metadata in association with the identified item(s) of content, wherein the metadata includes information indicative of the current mental or emotional state of the user during the time period when the user generated or interacted with the content. Such metadata can be used to organize and access content based on user mental or emotional state.

For example, each time a user takes a picture, content tagging logic 612, 632 or 642 may operate to store metadata in association with the picture that indicates the user's mental or emotional state at the time the picture was taken. Likewise, each time the user sends an e-mail, content tagging logic 612, 632 or 642 may operate to store metadata in association with the e-mail that indicates the user's mental or emotional state at the time the user sent the e-mail. As another example, each time the user watches a particular video, tagging logic 612, 632 or 642 may operate to store metadata in association with the video that indicates the user's mental or emotional state at the time the user watched the video. As yet another example, each time the user listens to a particular song, tagging logic 612, 632 or 642 may operate to store metadata in association with the song that indicates the user's mental or emotional state at the time the user listened to the song. As still another example, each time the user accesses a particular Web page, tagging logic 612, 632 or 642 may operate to store metadata in association with the Web page that indicates the user's mental or emotional state at the time the Web page was accessed. As a further example, each time the user accesses a particular application, tagging logic 612, 632 or 642 may operate to store metadata in association with the application that indicates the user's mental or emotional state at the time the user utilized the application. The metadata may be stored, for example, in memory on end user computing device 102 or in another device that is accessible to end user computing device 102.

By tagging user-generated or user-accessed content in this manner, embodiments enable such content to be indexed based on the mental/emotional state metadata. Thus, for example, digital personal assistant 130 or some other application or service can automatically organize a user's photos, e-mails, videos, songs, browsing history, applications, or other user-generated or user-accessed content based on the user's mental or emotional state. Also, since the content may be indexed by mental/emotional state, digital personal assistant 130 or some other application or service can easily search for user-generated content or user-accessed content based on the user's mental or emotional state. Thus, the user can conduct a search for her “happy” photos or “sad” photos. Furthermore, digital personal assistant 130 as well as other applications and services can use the metadata to automatically select content for the user that accords with a particular mental/emotional state. For example, a playlist of songs that the user listened to when she was happy can be automatically generated, and labeled “happy songs.” These are only a few examples.

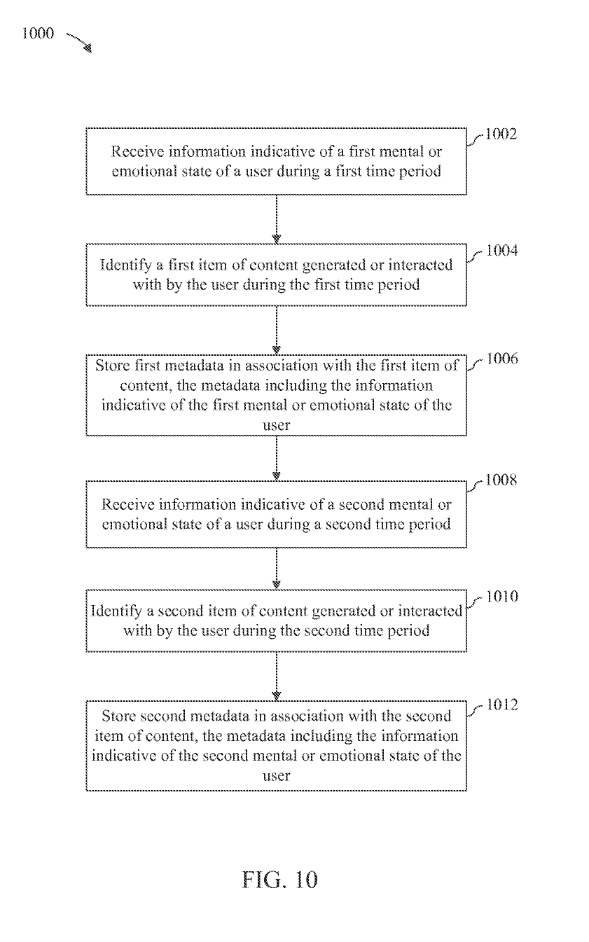

To further illustrate this concept, FIG. 10 depicts a flowchart 1000 of method for tagging content generated or interacted with by a user with metadata that includes information indicative of a mental or emotional state of the user. Each of the steps of flowchart 1000 may be performed by any one of content tagging logic 612, content tagging logic 632 or content tagging logic 642 as previously described in reference to system 600 of FIG. 6. However, the method is not limited to that system.

As shown in FIG. 10, the method of flowchart 1000 begins at step 1002, in which content tagging logic (e.g., any of content tagging logic 612, content tagging logic 632, or content tagging logic 642) receives information indicative of a first mental or emotional state of a user during a first time period. Such information may be generated by user mental/emotional state determination logic 610 based on one or more signals. The one or more signals may include comprise for example and without limitation, any of the signals discussed in Section II above as being useful for determining the mental or emotional state of a user. Thus, for example, the one or more signals may comprise one or more of: facial expressions of the user, voice characteristics of the user, a location of the user, an orientation of the user, a proximity of the user to other people or objects, a rate at which the user is turning on and off a mobile device; input device interaction metadata associated with the user, written and/or spoken content of the user, application interaction metadata associated with the user, accelerometer, compass and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

At step 1004, the content tagging logic (e.g., any of content tagging logic 612, content tagging logic 632, or content tagging logic 642) identifies a first item of content generate or interacted with by the user during the first time period. The first item of content may comprise, for example and without limitation, a photo, song, video, book, message, Web page, application, or the like.

At step 1006, the content tagging logic (e.g., any of content tagging logic 612, content tagging logic 632, or content tagging logic 642) stores first metadata in association with the first item of content. The first metadata includes the information indicative of the first mental or emotional state of the user.

At step 1008, the content tagging logic (e.g., any of content tagging logic 612, content tagging logic 632, or content tagging logic 642) receives information indicative of a second mental or emotional state of the user during a second time period, wherein the second mental or emotional state is different than the first mental or emotional state and the second time period is different than the first time period. The information may be generated by user mental/emotional state determination logic 610 based on one or more of the signals described above in reference to step 1002.

At step 1010, the content tagging logic (e.g., any of content tagging logic 612, content tagging logic 632, or content tagging logic 642) identifies a second item of content generated or interacted with by the user during the second time period. Like the first item of content, the second item of content may comprise, for example and without limitation, a photo, song, video, book, message, Web page, application, or the like.

At step 1006, the content tagging logic (e.g., any of content tagging logic 612, content tagging logic 632, or content tagging logic 642) stores second metadata in association with the second item of content. The second metadata includes the information indicative of the second mental or emotional state of the user.

The foregoing method may be repeated to store metadata in conjunction with any number of user-generated or user-accessed content items, wherein such metadata indicates the mental or emotional state of the user at the time such content item was generated or interacted with. As was noted above, such metadata can later be used to organize, index, and search for content based on mental or emotional state.

### VI. Example Mobile Device Implementation

FIG. 11 is a block diagram of an exemplary mobile device 1102 that may be used to implement end user computing device 102 as described above in reference to FIG. 1. As shown in FIG. 11, mobile device 1102 includes a variety of optional hardware and software components. Any component in mobile device 1102 can communicate with any other component, although not all connections are shown for ease of illustration. Mobile device 1102 can be any of a variety of computing devices (e.g., cell phone, smartphone, handheld computer, Personal Digital Assistant (PDA), etc.) and can allow wireless two-way communications with one or more mobile communications networks 1104, such as a cellular or satellite network, or with a local area or wide area network.

The illustrated mobile device 1102 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components of mobile device 1102 and support for one or more application programs 1114 (also referred to as “applications” or “apps”). Application programs 1114 may include common mobile computing applications (e.g., e-mail, calendar, contacts, Web browser, and messaging applications) and any other computing applications (e.g., word processing, mapping, and media player applications). In one embodiment, application programs 1114 include digital personal assistant 130.

The illustrated mobile device 1102 can include memory 1120. Memory 1120 can include non-removable memory 1122 and/or removable memory 1124. Non-removable memory 1122 can include RAM, ROM, flash memory, a hard disk, or other well-known memory devices or technologies. Removable memory 1124 can include flash memory or a Subscriber Identity Module (SIM) card, which is well known in GSM communication systems, or other well-known memory devices or technologies, such as “smart cards.” Memory 1120 can be used for storing data and/or code for running operating system 1112 and applications 1114. Example data can include Web pages, text, images, sound files, video data, or other data to be sent to and/or received from one or more network servers or other devices via one or more wired or wireless networks. Memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1102 can support one or more input devices 1130, such as a touch screen 1132, a microphone 1134, a camera 1136, a physical keyboard 1138 and/or a trackball 1140 and one or more output devices 1150, such as a speaker 1152 and a display 1154. Touch screens, such as touch screen 1132, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens.

Other possible output devices (not shown) can include piezoelectric or other haptic output devices. Some devices can serve more than one input/output function. For example, touch screen 1132 and display 1154 can be combined in a single input/output device. The input devices 1130 can include a Natural User Interface (NUI).

Wireless modem(s) 1160 can be coupled to antenna(s) (not shown) and can support two-way communications between the processor 1110 and external devices, as is well understood in the art. The modem(s) 1160 are shown generically and can include a cellular modem 1166 for communicating with the mobile communication network 1104 and/or other radio-based modems (e.g., Bluetooth 1164 and/or Wi-Fi 1162). At least one of the wireless modem(s) 1160 is typically configured for communication with one or more cellular networks, such as a GSM network for data and voice communications within a single cellular network, between cellular networks, or between the mobile device and a public switched telephone network (PSTN).

Mobile device 1102 can further include at least one input/output port 1180, a power supply 1182, a satellite navigation system receiver 1184, such as a Global Positioning System (GPS) receiver, an accelerometer 1186 (as well as other sensors, including but not limited to a compass and a gyroscope), and/or a physical connector 1190, which can be a USB port, IEEE 1394 (FireWire) port, and/or RS-232 port. The illustrated components of mobile device 1102 are not required or all-inclusive, as any components can be deleted and other components can be added as would be recognized by one skilled in the art.

In an embodiment, certain components of mobile device 1102 are configured to perform the operations attributed to digital personal assistant 130, user content/transaction feedback system 200, or system 600 as described in preceding sections. Computer program logic for performing the operations attributed to digital personal assistant 130, user content/transaction feedback system 200, or system 600 as described above may be stored in memory 1120 and executed by processor 1110. By executing such computer program logic, processor 1110 may be caused to implement any of the features of digital personal assistant 130, user content/activity feedback system 200, or system 600 as described above. Also, by executing such computer program logic, processor 1110 may be caused to perform any or all of the steps of any or all of the flowcharts depicted in FIGS. 4, 5, 8, 9 and 10.

### VII. Example Computer System Implementation

FIG. 12 depicts an example processor-based computer system 1200 that may be used to implement various embodiments described herein. For example, computer system 1200 may be used to implement end user computing device 102, digital personal assistant backend 106, user content/activity feedback system 200, or system 600 as described above. Computer system 1200 may also be used to implement any or all of the steps of any or all of the flowcharts depicted in FIGS. 4, 5, 8, 9 and 10. The description of computer system 1200 provided herein is provided for purposes of illustration, and is not intended to be limiting. Embodiments may be implemented in further types of computer systems, as would be known to persons skilled in the relevant art(s).

As shown in FIG. 12, computer system 1200 includes a processing unit 1202, a system memory 1204, and a bus 1206 that couples various system components including system memory 1204 to processing unit 1202. Processing unit 1202 may comprise one or more microprocessors or microprocessor cores. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer system 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, BLU-RAY™ disk or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1230, one or more application programs 1232, other program modules 1234, and program data 1236. In accordance with various embodiments, the program modules may include computer program logic that is executable by processing unit 1202 to perform any or all of the functions and features of end user computing device 102, digital personal assistant backend 106, user content/activity feedback system 200, or system 600 as described above. The program modules may also include computer program logic that, when executed by processing unit 1202, performs any of the steps or operations shown or described in reference to the flowcharts of FIGS. 4, 5, 8, 9 and 10.

A user may enter commands and information into computer system 1200 through input devices such as a keyboard 1238 and a pointing device 1240. Other input devices (not shown) may include a microphone, joystick, game controller, scanner, or the like. In one embodiment, a touch screen is provided in conjunction with a display 1244 to allow a user to provide user input via the application of a touch (as by a finger or stylus for example) to one or more points on the touch screen. These and other input devices are often connected to processing unit 1202 through a serial port interface 1242 that is coupled to bus 1206, but may be connected by other interfaces, such as a parallel port, game port, or a universal serial bus (USB). Such interfaces may be wired or wireless interfaces.

A display 1244 is also connected to bus 1206 via an interface, such as a video adapter 1246. In addition to display 1244, computer system 1200 may include other peripheral output devices (not shown) such as speakers and printers.

Computer system 1200 is connected to a network 1248 (e.g., a local area network or wide area network such as the Internet) through a network interface or adapter 1250, a modem 1252, or other suitable means for establishing communications over the network. Modem 1252, which may be internal or external, is connected to bus 1206 via serial port interface 1242.

As used herein, the terms “computer program medium,” “computer-readable medium,” and “computer-readable storage medium” are used to generally refer to memory devices or storage structures such as the hard disk associated with hard disk drive 1214, removable magnetic disk 1218, removable optical disk 1222, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable computer system 1200 to implement features of embodiments of the present invention discussed herein. Accordingly, such computer programs represent controllers of computer system 1200.

Embodiments are also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, computer system 1200 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### VIII. Additional Exemplary Embodiments

A method in accordance with an embodiment is performed by a digital personal assistant implemented on at least one computing device. The method includes: obtaining one or more signals associated with a user, determining a mental or emotional state of the user based on the one or more signals, and based on at least the determined mental or emotional state of the user, providing the user with feedback concerning one or more of an item of content generated by the user using the computing device and an activity to be conducted by the user using the computing device.

In one embodiment of the foregoing method, the one or more signals comprise one or more of: facial expressions of the user, voice characteristics of the user, a location of the user, an orientation of the user, a proximity of the user to other people or objects, a rate at which the user is turning on and off a mobile device, input device interaction metadata associated with the user, written and/or spoken content of the user, application interaction metadata associated with the user, accelerometer, compass, and/or gyroscope output, degree of exposure to light, temperature, air pressure, weather conditions, traffic conditions, pollution and/or allergen levels, activity level of the user, heart rate and heart rate variability of the user, electrodermal activity of the user, an EEG of the user, an ECG of the user, device and/or network connection information for a device associated with the user, battery and/or charging information for a device associated with the user, and a response provided by the user to at least one question concerning a mental or emotional state of the user.

In another embodiment of the foregoing method, providing the user with the feedback concerning the item of content generated by the user comprises suggesting to the user that a message generated thereby is not suitable for sharing with one or more intended recipients thereof.

In yet another embodiment of the foregoing method, providing the user with the feedback concerning the item of content generated by the user comprises highlighting one or more words, punctuation marks or emoticons included in text content generated by the user to indicate that such word(s), punctuation mark(s) or emoticon(s) comprise emotional content.

In still another embodiment of the foregoing method, providing the user with the feedback concerning the item of content generated by the user using the computing device comprises recommending that the user delete or replace one or more words, punctuation marks or emoticons included in text content generated by the user.

In a further embodiment of the foregoing method, recommending that the user replace one or more words included in the text content comprises identifying a list of words having a similar meaning to a word for which replacement is recommended, sorting the list by emotional content level, and presenting the sorted list to the user.

In a still further embodiment of the foregoing method, the user is provided with the feedback based on the determined mental or emotional state and at least one of a confidence level associated with the determined mental or emotional state or an intensity level associated with the mental or emotional state.

In an additional embodiment of the foregoing method, providing the user with the feedback concerning the item of content generated by the user using the computing device comprises recommending that the user share the content with at least one other person.

In another embodiment, the foregoing method further comprises determining how the user has responded to receiving the feedback, and automatically modifying how additional feedback will be presented to the user in the future based on the determined user response.

In yet another embodiment of the foregoing method, the activity to be conducted by the user via the computing device comprises one of: placing a phone call, sending a message, posting content to a social networking Web site, purchasing a good or service, taking a photograph, recording a video, or engaging in online gambling.

A system in accordance with an embodiment comprises at least one processor and a memory that stores computer program logic for execution by the at least one processor. The computer program logic includes one or more components configured to perform operations when executed by the at least one processor. The one or more components include a digital personal assistant and an API. The digital personal assistant is operable to monitor one or more signals associated with a user and to intermittently determine a current mental or emotional state of the user based on the monitored one or more signals. The API enables diverse applications and/or services to communicate with the digital personal assistant for the purpose of obtaining information about the current mental or emotional state of the user therefrom.

In one embodiment of the foregoing system, the one or more signals associated with the user comprise one or more of: facial expressions of the user, voice characteristics of the user, a location of the user, an orientation of the user, a proximity of the user to other people or objects, a rate at which the user is turning on and off a mobile device, input device interaction metadata associated with the user, written and/or spoken content of the user, application interaction metadata associated with the user, accelerometer, compass, and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

In another embodiment of the foregoing system, the API enables the diverse applications and/or services to query the digital personal assistant for the information about the current mental or emotional state of the user.

In yet another embodiment of the foregoing system, the API enables the diverse applications and/or services to register with the digital personal assistant to receive updates therefrom that include the information about the current mental or emotional state of the user.

In still another embodiment of the foregoing system, the information about the current emotional state of the user includes at least one identified mental or emotional state and at least one of a confidence level associated with the identified mental or emotional state and an intensity level associated with the identified mental or emotional state.

In a further embodiment of the foregoing system, the API further enables the diverse applications and/or services to communicate with the digital personal assistant for the purpose of obtaining therefrom a history of mental or emotional states of the user over time.

In a still further embodiment of the foregoing system, the API further enables the diverse applications and/or services to communicate with the digital personal assistant for the purpose of obtaining therefrom a predicted mental or emotional state of the user.

In an additional embodiment of the foregoing system, the API further enables the diverse applications and/or services to communicate with the digital personal assistant for the purpose of providing at least one of the one or more signals associated with the user.

A computer program product in accordance with an embodiment comprises a computer-readable memory having computer program logic recorded thereon that when executed by at least one processor causes the at least one processor to perform a method. The method includes: receiving information indicative of a first mental or emotional state of a user during a first time period, identifying a first item of content generated or interacted with by the user during the first time period, and storing first metadata in association with the first item of content, the first metadata including the information indicative of the first mental or emotional state of the user.

In one embodiment of the foregoing computer program product, the method further comprises: receiving information indicative of a second mental or emotional state of the user during a second time period, identifying a second item of content generated or interacted with by the user during the second time period, and storing second metadata in association with the second item of content, the second metadata including the information indicative of the second mental or emotional state of the user.

In another embodiment of the foregoing computer program product, the method further comprises determining the first mental or emotional state of the user based on an analysis of one or more of: facial expressions of the user, voice characteristics of the user, a location of the user, an orientation of the user, a proximity of the user to other people or devices, a rate at which the user is turning on and off a mobile device, input device interaction metadata associated with the user, written and/or spoken content of the user, application interaction metadata associated with the user, accelerometer, compass, and/or gyroscope output, degree of exposure to light, temperature, air pressure, weather conditions, traffic conditions, pollution and/or allergen levels, activity level of the user, heart rate and heart rate variability of the user, electrodermal activity of the user, an ECG of the user, an EEG of the user, device and/or network connection information for a device associated with the user, battery and/or charging information for a device associated with the user, and a response provided by the user to at least one question concerning a mental or emotional state of the user.

### IX. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method performed by a digital personal assistant implemented on at least one computing device, comprising:
obtaining one or more signals associated with a user;
determining a mental or emotional state of the user based on the one or more signals; and
based on at least the determined mental or emotional state of the user, providing the user with feedback concerning one or more of:
an item of content generated by the user using the computing device; and
an activity to be conducted by the user using the computing device.

2. The method of claim 1, wherein the one or more signals comprise one or more of:
facial expressions of the user;
voice characteristics of the user;
a location of the user;
an orientation of the user;
a proximity of the user to other people or objects;
a rate at which the user is turning on and off a mobile device;
input device interaction metadata associated with the user;
written and/or spoken content of the user;
application interaction metadata associated with the user;
accelerometer, compass, and/or gyroscope output;
degree of exposure to light;
temperature;
air pressure;
weather conditions;
traffic conditions;
pollution and/or allergen levels;
activity level of the user;
heart rate and heart rate variability of the user;
electrodermal activity of the user;
an electrocardiogram (ECG) of the user;
an electroencephalogram (EEG) of the user;
device and/or network connection information for a device associated with the user;
battery and/or charging information for a device associated with the user; and
a response provided by the user to at least one question concerning a mental or emotional state of the user.

3. The method of claim 1, wherein providing the user with the feedback concerning the item of content generated by the user comprises:
suggesting to the user that a message generated thereby is not suitable for sharing with one or more intended recipients thereof.

4. The method of claim 1, wherein providing the user with the feedback concerning the item of content generated by the user comprises:
highlighting one or more words, punctuation marks or emoticons included in text content generated by the user to indicate that such word(s), punctuation mark(s) or emoticon(s) comprise emotional content.

5. The method of claim 1, wherein providing the user with the feedback concerning the item of content generated by the user using the computing device comprises:
recommending that the user delete or replace one or more words, punctuation marks or emoticons included in text content generated by the user.

6. The method of claim 5, wherein recommending that the user replace one or more words included in the text content comprises:
identifying a list of words having a similar meaning to a word for which replacement is recommended;
sorting the list by emotional content level; and
presenting the sorted list to the user.

7. The method of claim 1, wherein the user is provided with the feedback based on the determined mental or emotional state and at least one of:
a confidence level associated with the determined mental or emotional state; or
an intensity level associated with the mental or emotional state.

8. The method of claim 1, wherein providing the user with the feedback concerning the item of content generated by the user using the computing device comprises:
recommending that the user share the content with at least one other person.

9. The method of claim 1, further comprising:
determining how the user has responded to receiving the feedback; and
automatically modifying how additional feedback will be presented to the user in the future based on the determined user response.

10. The method of claim 1, wherein the activity to be conducted by the user via the computing device comprises one of:
placing a phone call;
sending a message;
posting content to a social networking Web site;
purchasing a good or service;
taking a photograph;
recording a video; or
engaging in online gambling.

11. A system, comprising:
at least one processor; and
a memory that stores computer program logic for execution by the at least one processor, the computer program logic including one or more components configured to perform operations when executed by the at least one processor, the one or more components including:
a digital personal assistant operable to monitor one or more signals associated with a user and to intermittently determine a current mental or emotional state of the user based on the monitored one or more signals; and
an application programming interface (API) that enables diverse applications and/or services to communicate with the digital personal assistant for the purpose of obtaining information about the current mental or emotional state of the user therefrom.

12. The system of claim 11, wherein the one or more signals associated with the user comprise one or more of:
facial expressions of the user;
voice characteristics of the user;
a location of the user;
an orientation of the user;
a proximity of the user to other people or objects;
a rate at which the user is turning on and off a mobile device;
input device interaction metadata associated with the user;
written and/or spoken content of the user;
application interaction metadata associated with the user;
accelerometer, compass, and/or gyroscope output;
degree of exposure to light;
temperature;
air pressure;
weather conditions;
traffic conditions;
pollution and/or allergen levels;
activity level of the user;
heart rate and heart rate variability of the user;
electrodermal activity of the user;
an electrocardiogram (ECG) of the user;
an electroencephalogram (EEG) of the user;
device and/or network connection information for a device associated with the user;
battery and/or charging information for a device associated with the user; and
a response provided by the user to at least one question concerning a mental or emotional state of the user.

13. The system of claim 11, wherein the API enables the diverse applications and/or services to query the digital personal assistant for the information about the current mental or emotional state of the user.

14. The system of claim 11, wherein the API enables the diverse applications and/or services to register with the digital personal assistant to receive updates therefrom that include the information about the current mental or emotional state of the user.

15. The system of claim 11, wherein the information about the current emotional state of the user includes at least one identified mental or emotional state and at least one of:
a confidence level associated with the identified mental or emotional state; and
an intensity level associated with the identified mental or emotional state.

16. The system of claim 11, wherein the API further enables the diverse applications and/or services to communicate with the digital personal assistant for the purpose of obtaining therefrom at least one of:
a history of mental or emotional states of the user over time; and
a predicted mental or emotional state of the user.

17. The system of claim 11, wherein the API further enables the diverse applications and/or services to communicate with the digital personal assistant for the purpose of providing at least one of the one or more signals associated with the user.

18. A computer program product comprising a computer-readable memory having computer program logic recorded thereon that when executed by at least one processor causes the at least one processor to perform a method comprising:
receiving information indicative of a first mental or emotional state of a user during a first time period;
identifying a first item of content generated or interacted with by the user during the first time period; and
storing first metadata in association with the first item of content, the metadata including the information indicative of the first mental or emotional state of the user.

19. The computer program product of claim 18, wherein the method further comprises:
receiving information indicative of a second mental or emotional state of the user during a second time period;
identifying a second item of content generated or interacted with by the user during the second time period; and
storing second metadata in association with the second item of content, the metadata including the information indicative of the second mental or emotional state of the user.

20. The computer program product of claim 18, wherein the method further comprises:
determining the first mental or emotional state of the user based on an analysis of one or more of:
facial expressions of the user;
voice characteristics of the user;
a location of the user;
an orientation of the user;
a proximity of the user to other people or objects;
a rate at which the user is turning on and off a mobile device;
input device interaction metadata associated with the user;
written and/or spoken content of the user;
application interaction metadata associated with the user;
accelerometer, compass, and/or gyroscope output;
degree of exposure to light;
temperature;
air pressure;
weather conditions;
traffic conditions;
pollution and/or allergen levels;
activity level of the user;
heart rate and heart rate variability of the user;
electrodermal activity of the user;
an electrocardiogram (ECG) of the user;
an electroencephalogram (EEG) of the user;
device and/or network connection information for a device associated with the user;
battery and/or charging information for a device associated with the user; and
a response provided by the user to at least one question concerning a mental or emotional state of the user.
